(19) United States
(12) Patent Application Publication
(10) Pub. No.: US 2023/0294348 A1
(43) Pub. Date: Sep. 21, 2023

(54) BIODEGRADABLE LAMINATED SHEETS

(71) Applicant: TIPA CORP. LTD, Hod-HaSharon (IL)

(72) Inventor: Eli Lancry, Gan-Yavne (IL)

(21) Appl. No.: 18/008,977

(22) PCT Filed: Jun. 10, 2021
(86) PCT No.: PCT/IL2021/050698

§ 371 Date: Dec. 8, 2022

Related U.S. Application Data
(60) Provisional application No. 63/037,616, filed on Jun. 11, 2020.

(51) Int. Cl. B29C 48/21; B29C 48/00

(52) U.S. Cl. CPC B29C 48/21; B29C 48/022; B29K 2067/046

(57) ABSTRACT

Provided is a biodegradable laminated structure comprising a substrate and a tie layer, wherein said tie layer is selected from the group consisting of PBSA, PBS, PBAT and a mixture of PCL with PLA and combinations thereof. The laminated structure may comprise two, three, four, five or more layers and may be coated or uncoated.

### CROSS-REFERENCE TO RELATED APPLICATION

The present application gains priority from U.S. Provisional Application No. 63/037,616 filed 11 June, 2020, which is incorporated by reference as if fully set-forth herein.

### FIELD OF THE INVENTION

The present invention, in at least some embodiments, is directed to biodegradable structures, and in particular to biodegradable laminated structures comprising a tie layer consisting of at least one of PBSA, PBS, PBAT, mixture of PCL with PLA or combinations thereof.

### BACKGROUND OF THE INVENTION

The use of biodegradable materials had increased over the past years due to the environmentally beneficial properties of such materials. Such materials are now commonly used in the manufacture of a wide range of products, including various types of plastic bags and other forms of packaging.

Examples of such polymers include biopolymers based on polylactic acid (PLA), polyhydroxyalkanoates (PHA), which include polyhydroxybutyrate (PHB), polyhydroxyvalerate (PHV) and polyhydroxybutyrate-hydroxyvalerate copolymer (PHBV), and poly (epsilon-caprolactone) (PCL).

Each of the foregoing biopolymers has unique properties, benefits and weaknesses. For example, PHB and PLA tend to be strong but are also quite rigid or even brittle. This makes them poor candidates when flexible sheets are desired, such as for use in making wraps, bags and other packaging materials requiring good bend and folding capability.

On the other hand, biopolymers such as polybutylene adipate terphtalate (PBAT) are many times more flexible than the biopolymers discussed above and have relatively low melting points so that they tend to be self-adhering and unstable when newly processed and/or exposed to heat.

Further, due to the limited number of biodegradable polymers, it is often difficult, or even impossible, to identify a single polymer or copolymer that meets all, or even most, of the desired performance criteria for a given application.

Multi-layered sheets are often prepared by co-extru sion, wherein the separate layers adhere one to the other during the extrusion process. However, some multi-layered sheets do not adhere without the addition of a tie layer comprising an adhesive. Additionally, some multi-layered sheets are prepared by extrusion of the individual layers, followed by lamination, requiring the use of a tie layer comprising an adhesive. Adhesives commonly used in such tie layers include Morchem PS 255 ECO/CS-95, which are not biodegradable under home composting conditions, such that the home compostability of the sheet is reduced although each of the films in the laminate structure are themselves home compostable.

There is a need for materials which can effectively serve as a tie layer in the preparation of multi-layered biodegradable sheets which are themselves fully biodegradable under home composting conditions.

### SUMMARY OF THE INVENTION

According to an aspect of some embodiments of the present invention, there is provided a biodegradable laminated structure comprising a substrate and a tie layer, wherein said tie layer is selected from the group consisting of PBSA, PBS, PBAT and a mixture of PCL with PLA and combinations thereof.

According to an embodiment, the substrate is selected from the group consisting of paper, cellulose and combinations thereof.

According to an embodiment, the structure is a 2 ply structure consisting of said substrate and said tie layer. According to one such embodiment, the tie layer is a sealing sheet i.e. the tie layer functions also as a sealing sheet.

According to an embodiment, the structure is a 2 ply structure consisting of said substrate and a sealing sheet, wherein said sealing sheet comprises said tie layer and a sealing sheet outer layer.

According to an embodiment, the structure is a 2 ply structure consisting of said substrate and a sealing sheet, wherein said sealing sheet comprises said tie layer, a sealing sheet outer layer and a sealing sheet core layer provided between said tie layer and said sealing sheet outer layer.

According to an embodiment, the structure is a 3 ply structure consisting of said substrate; a sealing sheet comprising a sealing sheet outer layer and a sealing sheet second outer layer; and a tie layer provided between said substrate and said sealing sheet.

According to an embodiment of the 3 ply structure, said sealing sheet consists of a sealing sheet outer layer and a sealing sheet second outer layer.

According to an embodiment of the 3 ply structure, said sealing sheet comprises a sealing sheet outer layer, a sealing sheet second outer layer and a sealing sheet core layer provided between said sealing sheet outer layer and said sealing sheet second outer layer.

According to an embodiment, the structure is a 4 ply structure consisting of said substrate, a sealing sheet comprising a sealing sheet outer layer and a sealing sheet second outer layer, an intermediate layer provided on said sealing sheet second outer layer, and a tie layer provided between said substrate and said intermediate layer.

According to an embodiment of the 4 ply structure, said sealing sheet further comprises a sealing sheet core layer provided between said sealing sheet outer layer and said sealing sheet second outer layer.

According to an embodiment, the structure is a 5 ply structure consisting of said substrate, a first tie layer provided on said substrate, a sealing sheet comprising a sealing sheet outer layer and a sealing sheet second outer layer, a second tie layer provided on said sealing sheet second outer layer, and an intermediate layer provided between said first tie layer and said second tie layer.

According to an embodiment of the 5 ply structure, said intermediate layer is cellulose. According to an embodiment of any of the biodegradable laminated structures as disclosed herein, said tie layer comprises PBSA and further comprises PLA. According to one such embodiment, said tie layer comprises from 50 wt% to 85 wt% PBSA and from 15 wt% to 50 wt% PLA.

According to an embodiment of any of the biodegradable laminated structures as disclosed herein, said tie layer comprises PBAT and further comprises PLA. According to one such embodiment, said tie layer comprises from 50 wt% to 85 wt% PBAT and from 15 wt% to 50 wt% PLA.

According to an embodiment of any of the biodegradable laminated structures as disclosed herein, said tie layer comprises a mixture of 50 wt% to 80 wt% PLA and from 20 wt% to 50 wt% PCL.

According to an embodiment of any of the biodegradable laminated structures as disclosed herein, said tie layer comprises 100 wt% PBSA.

According to an embodiment of any of the biodegradable laminated structures as disclosed herein, said tie layer comprises 100 wt% PBAT.

According to an embodiment of any of the biodegradable laminated structures as disclosed herein, said sealing sheet outer layer is selected from the group consisting of PBSA, PBS, PBAT and a mixture of PCL with PLA and combinations thereof. According to one such embodiment, said sealing sheet outer layer comprises PBSA and further comprises PLA. According to one such embodiment, said sealing sheet outer layer comprises from 50 wt% to 85 wt% PBSA and from 15 wt% to 50 wt% PLA.

According to an embodiment, said sealing sheet outer layer comprises PBAT and further comprises PLA. According to one such embodiment, said sealing sheet outer layer comprises from 50 wt% to 85 wt% PBAT and from 15 wt% to 50 wt% PLA.

According to an embodiment, said sealing sheet outer layer comprises from 50 wt% to 80 wt% PLA and from 20 wt% to 50 wt% PCL.

According to an embodiment, said sealing sheet outer layer comprises 100 wt% PBSA. According to an embodiment, said sealing sheet outer layer comprises 100 wt% PBAT. According to an embodiment, wherein said sealing sheet comprises a sealing sheet core layer, said sealing sheet core layer is selected from the group consisting of PBSA, PBS,PBAT and a mixture of PCL with PLA and combinations thereof.

According to an embodiment, said sealing sheet core layer comprises PBSA and further comprises PLA.

According to an embodiment, said sealing sheet core layer comprises from 50 wt% to 85 wt% PBSA and from 15 wt% to 50 wt% PLA.

According to an embodiment, said sealing sheet core layer comprises PBAT and further comprises PLA.

According to an embodiment, said sealing sheet core layer comprises from 50 wt% to 85 wt% PBAT and from 15 wt% to 50 wt% PLA.

According to an embodiment, said sealing sheet core layer comprises from 50 wt% to 80 wt% PLA and from 20 wt% to 50 wt% PCL.

According to an embodiment, said sealing sheet core layer comprises 100 wt% PBSA. According to an embodiment, said sealing sheet core layer comprises 100 wt% PBAT. According to an embodiment, wherein said sealing sheet comprises a sealing sheet second outer layer, said sealing sheet second outer layer is selected from the group consisting of PBSA, PBS, PBAT and a mixture of PCL with PLA and combinations thereof.

According to an embodiment, said sealing sheet second outer layer comprises PBSA and further comprises PLA.

According to an embodiment, said sealing sheet second outer layer comprises from 50 wt% to 85 wt% PBSA and from 15 wt% to 50 wt% PLA.

According to an embodiment, said sealing sheet second outer layer comprises PBAT and further comprises PLA.

According to an embodiment, said sealing sheet second outer layer comprises from 50 wt% to 85 wt% PBAT and from 15 wt% to 50 wt% PLA.

According to an embodiment, sealing sheet second outer layer comprises from 50 wt% to 80 wt% PLA and from 20 wt% to 50 wt% PCL.

According to an embodiment, said sealing sheet second outer layer comprises 100 wt% PBSA.

According to an embodiment, said sealing sheet second outer layer comprises 100 wt% PBAT.

According to an embodiment, wherein said biodegradable laminated structure comprises an intermediate layer, said intermediate layer comprises cellulose. According to an embodiment, wherein said biodegradable laminated structure comprises a second tie layer, said second tie layer is selected from the group consisting of PBSA and PBAT.

According to an embodiment, said biodegradable laminated structure further comprising an additional layer selected from the group consisting of a metallization layer and a transparent metallization layer on an external surface of said sealing sheet outer layer. The biodegradable laminated structures of the present invention have a number of advantages as compared to similar laminates using commercial adhesives.

For example, the biodegradable laminated structures of the present invention require a short curing time at 38° C. as compared to similar laminates using commercial adhesives, which may require at least 4 days for each lamination stage, i.e. at least 8 days for a 5-ply laminate, resulting in logistical problems, such as delays in deliveries.

The biodegradable laminated structures of the present invention may be composted under home composting conditions, in contrast to similar laminates using commercial adhesives.

Preparation of the biodegradable laminated structures of the present invention does not require the use of solvents, so the process is more environmentally friendly and cleaner. In addition, the biodegradable laminated structures of the present invention use biopolymers rather than the small molecules commonly used in commercial adhesives, such that a better food contact profile is obtained.

Furthermore, commercial adhesives such as that produced by Morchem Ltd. (Barcelona, Spain) are highly sensitive to fats, such that when laminates using the commercially available adhesive are used for packaging of oily components, channels are frequently formed between adjacent layers of the laminate.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 is a schematic representation of the structure of a two-ply laminated structure in accordance with an embodiment of the present invention;

FIG. 2 is a schematic representation of the structure of a three-ply laminated structure in accordance with an embodiment of the present invention;

FIG. 3 is a schematic representation of the structure of a four-ply laminated structure in accordance with an embodiment of the present invention; and

FIG. 4 is a schematic representation of the structure of a five-ply laminated structure in accordance with an embodiment of the present invention.

### DETAILED DESCRIPTION OF THE INVENTION

### Definitions

Unless otherwise defined, all technical and scientific terms used herein have the same meaning as commonly understood by one of ordinary skill in the art to which the invention pertains. In case of conflict, the specification, including definitions, takes precedence.

The term “biodegradable” as used herein is to be understood to include a polymer, polymer mixture, or polymer-containing sheet or laminated structure that degrades through the action of living organisms in air, water or any combinations thereof within 1 year. Biodegradable polyester degradation is initially by hydrolysis, to eventually break the polymer into short oligomers, and later by microbial degradation, or microbial digestion. Biodegradable material may break down under a variety of conditions, for example under aerobic or anaerobic conditions, in compost, in soil or in water (such as sea, rivers or other waterways).

Material which may be degraded in compost is referred to as compostable. Hence, as used herein, the term “compostable” refers to a polymer, polymer mixture, or polymer-containing sheet which is degraded by biological processes under aerobic conditions to yield carbon dioxide, water, inorganic compounds and biomass and leaves no visible, distinguishable or toxic residues. Composting of such materials may require a commercial composting facility or the material may be home compostable.

As used herein, the term “home compostable” refers to a polymer, polymer mixture, or polymer-containing sheet which is compostable in a home composting container, i.e. at significantly lower temperatures and in the absence of set conditions as compared to those provided in a commercial composting facility, Home composting is usually carried out in significantly smaller volumes than those used for commercial composting, and do not include an industrial shredding process.

The term “sheet” as used herein is to be understood as having its customary meanings as used in the thermoplastic and packaging arts and includes the term “film”. Such sheets may have any suitable thickness, may be of a single polymer layer or of multiple polymer layers. Such sheets may be manufactured using any suitable method including blown film extrusion and cast film extrusion.

As used herein, the term “laminated structure” (also referred to as “structure” or “laminate”) refers to a structure comprising at least two layers or sheets.

As used herein, the term “tie layer” refers to a layer of polymer resin which can adhere to an adjacent polymer layer, optionally providing adhesion between two poorly adhering polymer layers. According to some embodiments, the tie layer has a thickness in the range of from about 12 to about 30 microns.

As used herein, the term “substrate” refers to an outer layer of the laminated structure i.e. a layer which is furthest from the product when the laminated structure as disclosed herein is used in packaging.

As used herein, the term “sealing layer” refers to a layer which provides a product side surface of the laminated structure i.e. a layer intended for contact with a product when the laminated structure as disclosed herein is used in packaging. According to some embodiments, a sealing layer for extrusion coating has a thickness in the range of from about 20 to about 60 microns.

As used herein, the term “intermediate layer” refers to a layer within the inner and outer layers of the laminated structure e.g. between the substrate and the tie layer, wherein the intermediate layer is not a tie layer.

It is to be noted that, as used herein, the singular forms “a”, “an” and “the” include plural forms unless the content clearly dictates otherwise. Where aspects or embodiments are described in terms of Markush groups or other grouping of alternatives, those skilled in the art will recognize that the invention is also thereby described in terms of any individual member or subgroup of members of the group.

As used herein, when a numerical value is preceded by the term “about”, the term “about” is intended to indicate +/-10%.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

In some embodiments, the biodegradable laminated structure as disclosed herein is used to prepare a biodegradable package, such as a bag or pouch, for example for containing therein an ingestible substance such as a food, drink or medicine, which may be a solid, semi-solid or liquid substance; or for containing therein a non-ingestible substance such as an item of clothing, a toiletry or cosmetic material or the like. For example, in some embodiments, the biodegradable package is prepared by heat sealing of two or more parts of the same laminate or two or more separate laminates.

As known to a person having ordinary skill in the art, some of the polymers discussed herein have one or more names or spelling thereof. For example, poly(epsilon-caprolactone), poly(caprolactone) and polycaprolactone are synonymous and the three terms are used interchangeably. Similarly, polylactic acid and poly(lactic acid) are synonymous.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Many modifications and variations are possible in light of the above teachings. It is, therefore, to be understood that within the scope of the appended claims, the invention can be practiced otherwise than as specifically described.

The specific embodiments listed below exemplify aspects of the teachings herein and are not to be construed as limiting.

Throughout this application, various publications, including United States Patents, are referenced by author and year and patents by number. The disclosures of these publications and patents and patent applications in their entireties are hereby incorporated by reference into this application in order to more fully describe the state of the art to which this invention pertains.

Citation of any document herein is not intended as an admission that such document is pertinent prior art or considered material to the patentability of any claim of the present disclosure. Any statement as to content or a date of any document is based on the information available to applicant at the time of filing and does not constitute an admission as to the correctness of such a statement.

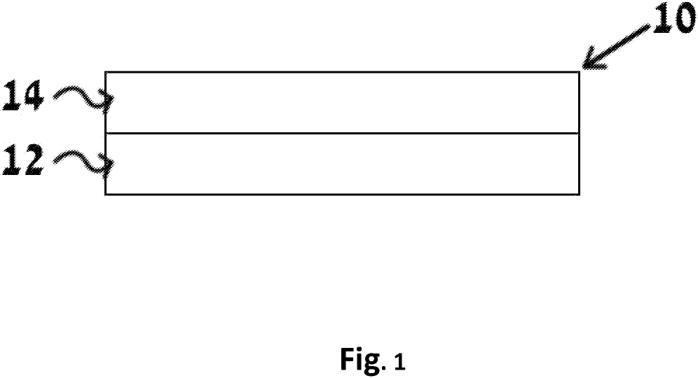

Referring now to FIG. 1, there is shown a schematic representation of a two-ply laminated structure 10, comprising a substrate 12; and a tie layer 14.

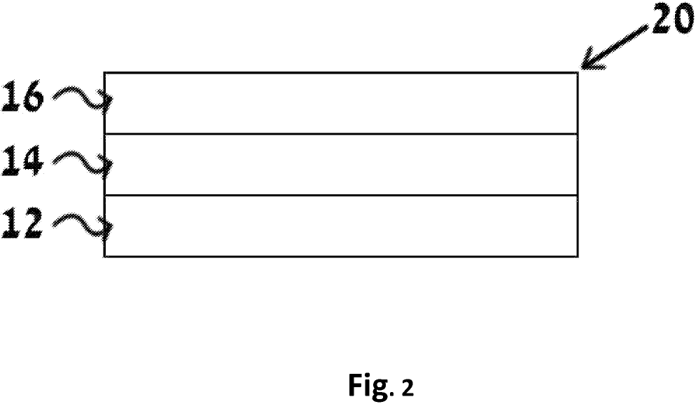

FIG. 2 shows a schematic representation of a three-ply laminated structure 20 comprising a substrate 12; a sealing sheet 16 and a tie layer 14 positioned between substrate 12 and sealing sheet 16.

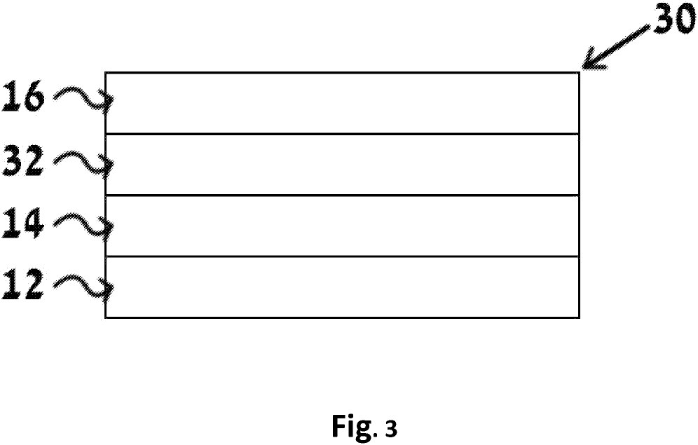

FIG. 3 shows a schematic representation of a four-ply laminated structure 30 comprising a substrate 12, a sealing sheet 16, an intermediate layer 32 between substrate 12 and sealing sheet 16; and a tie layer 14 between substrate 12 and intermediate layer 32.

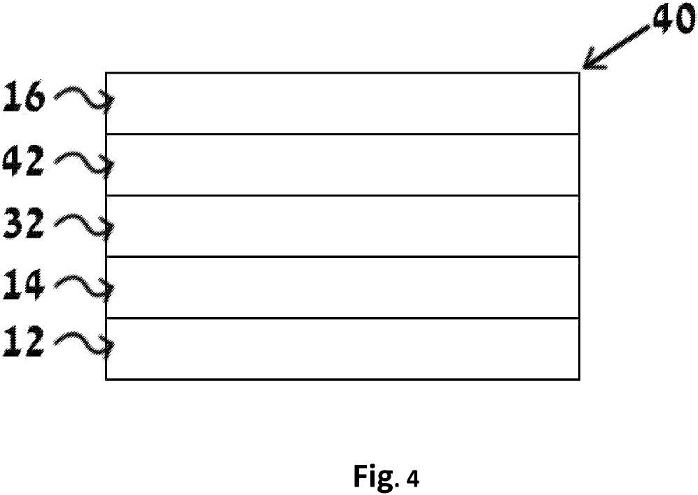

FIG. 4 shows a schematic representation of a five-ply laminated structure 40 comprising a substrate 12, a sealing sheet 16, an intermediate layer 32 between substrate 12 and sealing sheet 16; a tie layer 14 between substrate 12 and intermediate layer 32; and a second tie layer 42 between intermediate layer 32 and sealing sheet 16.

### EXAMPLES

In the experimental section below, all percentages are weight percentages.

### Materials and Methods

All the embodiments of polymer sheets according to the teachings herein are made using commercially-available raw materials and devices, using one or more standard methods including: polymer resin drying, resin mixing, cast film extrusion, cast film co-extrusion, metallization and thermal lamination.

### Materials

The following polymer resins and raw materials are acquired from commercial sources:
PBSA poly(butylene succinate)
PBAT poly(butylene adipate terphtalate)
PLA poly(lactic acid)
PCL poly(epsilon-caprolactone)
Cellulose
Paper

### Resin Drying

Before use, resins are dried overnight in an air flow Shini SCD-160U-120H dryer desiccator heated to 50° C.

### Resin Mixtures

To make the required polymer mixture resins, the appropriate amounts of the dried constituent resins are dry-blended, introduced into the feed of a twin screw compounder and then melt extruded to form a polymer mixture resin. During melt extrusion in the compounder, the temperature zone settings are 170-175-180-185-190° C. Die at 190° C., a screw speed of 350 rpm and pressure 15-25 bar.

The compounded polymer resin is ground into 1-5 mm diameter pellets using strand pelletizer.

### Extrusion Processes

Some embodiments of sheets according to the teachings herein are made by extrusion lamination and/or extrusion coating to produce the desired laminated structure.

Sheets are made using a co-extrusion line from Collin (Collin Lab and Pilot Solutions) equipped with two unwinders using standard settings, typically the mixture is feed into the extruder with the temperature zone settings 170-180-200° C.; Adaptor at 200° C.; feedblock at 200° C.; Die at 200° C. The screw speed is set to provide an extruded layer having the desired thickness in the usual way.

### Metallization

Metallization is performed using a physical vapor deposition process with aluminum vapor under vacuum (for standard metallization) or vacuum and oxygen (for transparent metallization).

### Coating

A thin film coating of coating is optionally applied on the different sheets at a 3 g/m² concentration. In metallized films, the coating is applied on the metallized side. The film is dried overnight at ambient temperature.

### Example 1: Laminates Comprising 2 Ply Structures Wherein Sealing Sheet Is Monolayer

TABLE 1

| Sheet # | Substrate | Sealing sheet as tie layer |
|---|---|---|
| 1 | Cellulose | 50 wt% PBSA:50 wt% PLA |
| 2 | Cellulose | 65 wt% PBSA:35 wt% PLA |
| 3 | Cellulose | 75 wt% PBSA:25 wt% PLA |
| 4 | Cellulose | 85 wt% PBSA:15 wt% PLA |
| 5 | Cellulose | 50 wt% PBAT:50 wt% PLA |
| 6 | Cellulose | 65 wt% PBAT:35 wt% PLA |
| 7 | Cellulose | 75 wt% PBAT:25 wt% PLA |
| 8 | Cellulose | 85 wt% PBAT:15 wt% PLA |
| 9 | Cellulose | 50% PLA:50% PCL |
| 10 | Cellulose | 60% PLA:40% PCL |
| 11 | Cellulose | 70% PLA:30% PCL |
| 12 | Cellulose | 80% PLA:20% PCL |
| 13 | Paper | 50 wt% PBSA:50 wt% PLA |
| 14 | Paper | 65 wt% PBSA:35 wt% PLA |
| 15 | Paper | 75 wt% PBSA:25 wt% PLA |
| 16 | Paper | 85 wt% PBSA:15 wt% PLA |
| 17 | Paper | 50 wt% PBAT:50 wt% PLA |
| 18 | Paper | 65 wt% PBAT:35 wt% PLA |
| 19 | Paper | 75 wt% PBAT:25 wt% PLA |
| 20 | Paper | 85 wt% PBAT:15 wt% PLA |
| 21 | Paper | 50% PLA:50% PCL |
| 22 | Paper | 60% PLA:40% PCL |
| 23 | Paper | 70% PLA:30% PCL |
| 24 | Paper | 80% PLA:20% PCL |

### Example 2: Laminates Comprising 2 Ply Structures Wherein Sealing Sheet Is Two Layered Sheet

TABLE 2

| Sheet # | Substrate | Sealing sheet | |
|---|---|---|---|
| | | Tie layer/sheet second outer layer | Sheet outer layer |
| 25 | Cellulose | 100% PBAT | 50 wt% PBSA:50 wt% PLA |
| 26 | Cellulose | 100% PBAT | 65 wt% PBSA:35 wt% PLA |
| 27 | Cellulose | 100% PBAT | 75 wt% PBSA:25 wt% PLA |
| 28 | Cellulose | 100% PBAT | 85 wt% PBSA:15 wt% PLA |
| 29 | Cellulose | 100% PBAT | 50 wt% PBAT:50 wt% PLA |
| 30 | Cellulose | 100% PBAT | 65 wt% PBAT:35 wt% PLA |
| 31 | Cellulose | 100% PBAT | 75 wt% PBAT:25 wt% PLA |
| 32 | Cellulose | 100% PBAT | 85 wt% PBAT:15 wt% PLA |
| 33 | Cellulose | 100% PBAT | 50% PLA:50% PCL |
| 34 | Cellulose | 100% PBAT | 60% PLA:40% PCL |
| 35 | Cellulose | 100% PBAT | 70% PLA:30% PCL |
| 36 | Cellulose | 100% PBAT | 80% PLA:20% PCL |
| 37 | Cellulose | 100% PBSA | 50 wt% PBSA:50 wt% PLA |
| 38 | Cellulose | 100% PBSA | 65 wt% PBSA:35 wt% PLA |
| 39 | Cellulose | 100% PBSA | 75 wt% PBSA:25 wt% PLA |
| 40 | Cellulose | 100% PBSA | 85 wt% PBSA:15 wt% PLA |
| 41 | Cellulose | 100% PBSA | 50 wt% PBAT:50 wt% PLA |
| 42 | Cellulose | 100% PBSA | 65 wt% PBAT:35 wt% PLA |
| 43 | Cellulose | 100% PBSA | 75 wt% PBAT:25 wt% PLA |
| 44 | Cellulose | 100% PBSA | 85 wt% PBAT:15 wt% PLA |
| 45 | Cellulose | 100% PBSA | 50% PLA:50% PCL |
| 46 | Cellulose | 100% PBSA | 60% PLA:40% PCL |
| 47 | Cellulose | 100% PBSA | 70% PLA:30% PCL |
| 48 | Cellulose | 100% PBSA | 80% PLA:20% PCL |
| 49 | Paper | 100% PBAT | 50 wt% PBSA:50 wt% PLA |
| 50 | Paper | 100% PBAT | 65 wt% PBSA:35 wt% PLA |
| 51 | Paper | 100% PBAT | 75 wt% PBSA:25 wt% PLA |
| 52 | Paper | 100% PBAT | 85 wt% PBSA:15 wt% PLA |
| 53 | Paper | 100% PBAT | 50 wt% PBAT:50 wt% PLA |
| 54 | Paper | 100% PBAT | 65 wt% PBAT:35 wt% PLA |
| 55 | Paper | 100% PBAT | 75 wt% PBAT:25 wt% PLA |
| 56 | Paper | 100% PBAT | 85 wt% PBAT:15 wt% PLA |
| 57 | Paper | 100% PBAT | 50% PLA:50% PCL |
| 58 | Paper | 100% PBAT | 60% PLA:40% PCL |
| 59 | Paper | 100% PBAT | 70% PLA:30% PCL |
| 60 | Paper | 100% PBAT | 80% PLA:20% PCL |
| 61 | Paper | 100% PBSA | 50 wt% PBSA:50 wt% PLA |
| 62 | Paper | 100% PBSA | 65 wt% PBSA:35 wt% PLA |
| 63 | Paper | 100% PBSA | 75 wt% PBSA:25 wt% PLA |
| 64 | Paper | 100% PBSA | 85 wt% PBSA:15 wt% PLA |
| 65 | Paper | 100% PBSA | 50 wt% PBAT:50 wt% PLA |
| 66 | Paper | 100% PBSA | 65 wt% PBAT:35 wt% PLA |
| 67 | Paper | 100% PBSA | 75 wt% PBAT:25 wt% PLA |
| 68 | Paper | 100% PBSA | 85 wt% PBAT:15 wt% PLA |
| 69 | Paper | 100% PBSA | 50% PLA:50% PCL |
| 70 | Paper | 100% PBSA | 60% PLA:40% PCL |
| 71 | Paper | 100% PBSA | 70% PLA:30% PCL |
| 72 | Paper | 100% PBSA | 80% PLA:20% PCL |
| 73 | Cellulose | 50 wt% PBSA:50 wt% PLA | 100% PBAT |
| 74 | Cellulose | 65 wt% PBSA:35 wt% PLA | 100% PBAT |
| 75 | Cellulose | 75 wt% PBSA:25 wt% PLA | 100% PBAT |
| 76 | Cellulose | 85 wt% PBSA:15 wt% PLA | 100% PBAT |
| 77 | Cellulose | 50 wt% PBAT:50 wt% PLA | 100% PBAT |
| 78 | Cellulose | 65 wt% PBAT:35 wt% PLA | 100% PBAT |
| 79 | Cellulose | 75 wt% PBAT:25 wt% PLA | 100% PBAT |
| 80 | Cellulose | 85 wt% PBAT:15 wt% PLA | 100% PBAT |
| 81 | Cellulose | 50% PLA:50% PCL | 100% PBAT |
| 82 | Cellulose | 60% PLA:40% PCL | 100% PBAT |
| 83 | Cellulose | 70% PLA:30% PCL | 100% PBAT |
| 84 | Cellulose | 80% PLA:20% PCL | 100% PBAT |
| 85 | Cellulose | 50 wt% PBSA:50 wt% PLA | 100% PBSA |
| 86 | Cellulose | 65 wt% PBSA:35 wt% PLA | 100% PBSA |
| 87 | Cellulose | 75 wt% PBSA:25 wt% PLA | 100% PBSA |
| 88 | Cellulose | 85 wt% PBSA:15 wt% PLA | 100% PBSA |
| 89 | Cellulose | 50 wt% PBAT:50 wt% PLA | 100% PBSA |
| 90 | Cellulose | 65 wt% PBAT:35 wt% PLA | 100% PBSA |
| 91 | Cellulose | 75 wt% PBAT:25 wt% PLA | 100% PBSA |
| 92 | Cellulose | 85 wt% PBAT:15 wt% PLA | 100% PBSA |
| 93 | Cellulose | 50% PLA:50% PCL | 100% PBSA |
| 94 | Cellulose | 60% PLA:40% PCL | 100% PBSA |
| 95 | Cellulose | 70% PLA:30% PCL | 100% PBSA |
| 96 | Cellulose | 80% PLA:20% PCL | 100% PBSA |
| 97 | Paper | 50 wt% PBSA:50 wt% PLA | 100% PBAT |
| 98 | Paper | 65 wt% PBSA:35 wt% PLA | 100% PBAT |
| 99 | Paper | 75 wt% PBSA:25 wt% PLA | 100% PBAT |
| 100 | Paper | 85 wt% PBSA:15 wt% PLA | 100% PBAT |
| 101 | Paper | 50 wt% PBAT:50 wt% PLA | 100% PBAT |
| 102 | Paper | 65 wt% PBAT:35 wt% PLA | 100% PBAT |
| 103 | Paper | 75 wt% PBAT:25 wt% PLA | 100% PBAT |
| 104 | Paper | 85 wt% PBAT:15 wt% PLA | 100% PBAT |
| 105 | Paper | 50% PLA:50% PCL | 100% PBAT |
| 106 | Paper | 60% PLA:40% PCL | 100% PBAT |
| 107 | Paper | 70% PLA:30% PCL | 100% PBAT |
| 108 | Paper | 80% PLA:20% PCL | 100% PBAT |
| 109 | Paper | 50 wt% PBSA:50 wt% PLA | 100% PBSA |
| 110 | Paper | 65 wt% PBSA:35 wt% PLA | 100% PBSA |
| 111 | Paper | 75 wt% PBSA:25 wt% PLA | 100% PBSA |
| 112 | Paper | 85 wt% PBSA:15 wt% PLA | 100% PBSA |
| 113 | Paper | 50 wt% PBAT:50 wt% PLA | 100% PBSA |
| 114 | Paper | 65 wt% PBAT:35 wt% PLA | 100% PBSA |
| 115 | Paper | 75 wt% PBAT:25 wt% PLA | 100% PBSA |
| 116 | Paper | 85 wt% PBAT:15 wt% PLA | 100% PBSA |
| 117 | Paper | 50% PLA:50% PCL | 100% PBSA |
| 118 | Paper | 60% PLA:40% PCL | 100% PBSA |
| 119 | Paper | 70% PLA:30% PCL | 100% PBSA |
| 120 | Paper | 80% PLA:20% PCL | 100% PBSA |

### Example 3: Laminates Comprising 2 Ply Structures Wherein Sealing Sheet Is Three Layered Sheet

TABLE 3

| Sheet # | Substrate | Sealing sheet | | |
|---|---|---|---|---|
| | | Tie layer/sheet second outer layer | Core layer | Sheet outer layer |
| 121 | Cellulose | 50 wt% PBSA:50 wt% PLA | 100% PBAT | 50 wt% PBSA:50 wt% PLA |
| 122 | Cellulose | 65 wt% PBSA:35 wt% PLA | 100% PBAT | 65 wt% PBSA:35 wt% PLA |
| 123 | Cellulose | 75 wt% PBSA:25 wt% PLA | 100% PBAT | 75 wt% PBSA:25 wt% PLA |
| 124 | Cellulose | 85 wt% PBSA:15 wt% PLA | 100% PBAT | 85 wt% PBSA:15 wt% PLA |
| 125 | Cellulose | 50 wt% PBAT:50 wt% PLA | 100% PBAT | 50 wt% PBAT:50 wt% PLA |
| 126 | Cellulose | 65 wt% PBAT:35 wt% PLA | 100% PBAT | 65 wt% PBAT:35 wt% PLA |
| 127 | Cellulose | 75 wt% PBAT:25 wt% PLA | 100% PBAT | 75 wt% PBAT:25 wt% PLA |
| 128 | Cellulose | 85 wt% PBAT:15 wt% PLA | 100% PBAT | 85 wt% PBAT:15 wt% PLA |
| 129 | Cellulose | 50% PLA:50% PCL | 100% PBAT | 50% PLA:50% PCL |
| 130 | Cellulose | 60% PLA:40% PCL | 100% PBAT | 60% PLA:40% PCL |
| 131 | Cellulose | 70% PLA:30% PCL | 100% PBAT | 70% PLA:30% PCL |
| 132 | Cellulose | 80% PLA:20% PCL | 100% PBAT | 80% PLA:20% PCL |
| 133 | Cellulose | 50 wt% PBSA:50 wt% PLA | 100% PBSA | 50 wt% PBSA:50 wt% PLA |
| 134 | Cellulose | 65 wt% PBSA:35 wt% PLA | 100% PBSA | 65 wt% PBSA:35 wt% PLA |
| 135 | Cellulose | 75 wt% PBSA:25 wt% PLA | 100% PBSA | 75 wt% PBSA:25 wt% PLA |
| 136 | Cellulose | 85 wt% PBSA:15 wt% PLA | 100% PBSA | 85 wt% PBSA:15 wt% PLA |
| 137 | Cellulose | 50 wt% PBAT:50 wt% PLA | 100% PBSA | 50 wt% PBAT:50 wt% PLA |
| 138 | Cellulose | 65 wt% PBAT:35 wt% PLA | 100% PBSA | 65 wt% PBAT:35 wt% PLA |
| 139 | Cellulose | 75 wt% PBAT:25 wt% PLA | 100% PBSA | 75 wt% PBAT:25 wt% PLA |
| 140 | Cellulose | 85 wt% PBAT:15 wt% PLA | 100% PBSA | 85 wt% PBAT:15 wt% PLA |
| 141 | Cellulose | 50% PLA:50% PCL | 100% PBSA | 50% PLA:50% PCL |
| 142 | Cellulose | 60% PLA:40% PCL | 100% PBSA | 60% PLA:40% PCL |
| 143 | Cellulose | 70% PLA:30% PCL | 100% PBSA | 70% PLA:30% PCL |
| 144 | Cellulose | 80% PLA:20% PCL | 100% PBSA | 80% PLA:20% PCL |
| 145 | Paper | 50 wt% PBSA:50 wt% PLA | 100% PBAT | 50 wt% PBSA:50 wt% PLA |
| 146 | Paper | 65 wt% PBSA:35 wt% PLA | 100% PBAT | 65 wt% PBSA:35 wt% PLA |
| 147 | Paper | 75 wt% PBSA:25 wt% PLA | 100% PBAT | 75 wt% PBSA:25 wt% PLA |
| 148 | Paper | 85 wt% PBSA:15 wt% PLA | 100% PBAT | 85 wt% PBSA:15 wt% PLA |
| 149 | Paper | 50 wt% PBAT:50 wt% PLA | 100% PBAT | 50 wt% PBAT:50 wt% PLA |
| 150 | Paper | 65 wt% PBAT:35 wt% PLA | 100% PBAT | 65 wt% PBAT:35 wt% PLA |
| 151 | Paper | 75 wt% PBAT:25 wt% PLA | 100% PBAT | 75 wt% PBAT:25 wt% PLA |
| 152 | Paper | 85 wt% PBAT:15 wt% PLA | 100% PBAT | 85 wt% PBAT:15 wt% PLA |
| 153 | Paper | 50% PLA:50% PCL | 100% PBAT | 50% PLA:50% PCL |
| 154 | Paper | 60% PLA:40% PCL | 100% PBAT | 60% PLA:40% PCL |
| 155 | Paper | 70% PLA:30% PCL | 100% PBAT | 70% PLA:30% PCL |
| 156 | Paper | 80% PLA:20% PCL | 100% PBAT | 80% PLA:20% PCL |
| 157 | Paper | 50 wt% PBSA:50 wt% PLA | 100% PBSA | 50 wt% PBSA:50 wt% PLA |
| 158 | Paper | 65 wt% PBSA:35 wt% PLA | 100% PBSA | 65 wt% PBSA:35 wt% PLA |
| 159 | Paper | 75 wt% PBSA:25 wt% PLA | 100% PBSA | 75 wt% PBSA:25 wt% PLA |
| 160 | Paper | 85 wt% PBSA:15 wt% PLA | 100% PBSA | 85 wt% PBSA:15 wt% PLA |
| 161 | Paper | 50 wt% PBAT:50 wt% PLA | 100% PBSA | 50 wt% PBAT:50 wt% PLA |
| 162 | Paper | 65 wt% PBAT:35 wt% PLA | 100% PBSA | 65 wt% PBAT:35 wt% PLA |
| 163 | Paper | 75 wt% PBAT:25 wt% PLA | 100% PBSA | 75 wt% PBAT:25 wt% PLA |
| 164 | Paper | 85 wt% PBAT:15 wt% PLA | 100% PBSA | 85 wt% PBAT:15 wt% PLA |
| 165 | Paper | 50% PLA:50% PCL | 100% PBSA | 50% PLA:50% PCL |
| 166 | Paper | 60% PLA:40% PCL | 100% PBSA | 60% PLA:40% PCL |
| 167 | Paper | 70% PLA:30% PCL | 100% PBSA | 70% PLA:30% PCL |
| 168 | Paper | 80% PLA:20% PCL | 100% PBSA | 80% PLA:20% PCL |
| 169 | Paper | 100% PBSA | 50 wt% PBSA: 50 wt% PLA | 100% PBSA |
| 170 | Paper | 100% PBSA | 65 wt% PBSA: 35 wt% PLA | 100% PBSA |
| 171 | Paper | 100% PBSA | 75 wt% PBSA: 25 wt% PLA | 100% PBSA |
| 172 | Paper | 100% PBSA | 85 wt% PBSA: 15 wt% PLA | 100% PBSA |
| 173 | Paper | 100% PBSA | 50 wt% PBAT: 50 wt% PLA | 100% PBSA |
| 174 | Paper | 100% PBSA | 65 wt% PBAT: 35 wt% PLA | 100% PBSA |
| 175 | Paper | 100% PBSA | 75 wt% PBAT: 25 wt% PLA | 100% PBSA |
| 176 | Paper | 100% PBSA | 85 wt% PBAT: 15 wt% PLA | 100% PBSA |
| 177 | Paper | 100% PBSA | 50% PLA: 50% PCL | 100% PBSA |
| 178 | Paper | 100% PBSA | 60% PLA: 140% PCL | 100% PBSA |
| 179 | Paper | 100% PBSA | 70% PLA: 30% PCL | 100% PBSA |
| 180 | Paper | 100% PBSA | 80% PLA: 20% PCL | 100% PBSA |
| 181 | Paper | 100% PBS | 70% PLA: 30% PCL | 100% PBS |

### Example 4: Laminates Comprising 3 Ply Structures Wherein Sealing Sheet Is Three Layered sheet

TABLE 4

| Sheet # | Substrate | Tie layer | Sealing sheet | | |
|---|---|---|---|---|---|
| | | | Sheet second outer layer | Core layer | Sheet outer layer |
| 182 | Cellulose | 100% PBSA | 50 wt% PBSA: 50 wt% PLA | 100% PBAT | 50 wt% PBSA: 50 wt% PLA |
| 183 | Cellulose | 100% PBSA | 65 wt% PBSA: 35 wt% PLA | 100% PBAT | 65 wt% PBSA: 35 wt% PLA |
| 184 | Cellulose | 100% PBSA | 75 wt% PBSA: 25 wt% PLA | 100% PBAT | 75 wt% PBSA: 25 wt% PLA |
| 185 | Cellulose | 100% PBSA | 85 wt% PBSA: 15 wt% PLA | 100% PBAT | 85 wt% PBSA: 15 wt% PLA |
| 186 | Cellulose | 100% PBSA | 50 wt% PBAT: 50 wt% PLA | 100% PBAT | 50 wt% PBAT: 50 wt% PLA |
| 187 | Cellulose | 100% PBSA | 65 wt% PBAT: 35 wt% PLA | 100% PBAT | 65 wt% PBAT: 35 wt% PLA |
| 188 | Cellulose | 100% PBSA | 75 wt% PBAT: 25 wt% PLA | 100% PBAT | 75 wt% PBAT: 25 wt% PLA |
| 189 | Cellulose | 100% PBSA | 85 wt% PBAT: 15 wt% PLA | 100% PBAT | 85 wt% PBAT: 15 wt% PLA |
| 190 | Cellulose | 100% PBSA | 50% PLA: 50% PCL | 100% PBAT | 50% PLA: 50% PCL |
| 191 | Cellulose | 100% PBSA | 60% PLA: 40% PCL | 100% PBAT | 60% PLA: 40% PCL |
| 192 | Cellulose | 100% PBSA | 70% PLA: 30% PCL | 100% PBAT | 70% PLA: 30% PCL |
| 193 | Cellulose | 100% PBSA | 80% PLA: 20% PCL | 100% PBAT | 80% PLA: 20% PCL |
| 194 | Cellulose | 100% PBAT | 50 wt% PBSA: 50 wt% PLA | 100% PBSA | 50 wt% PBSA: 50 wt% PLA |
| 195 | Cellulose | 100% PBAT | 65 wt% PBSA: 35 wt% PLA | 100% PBSA | 65 wt% PBSA: 35 wt% PLA |
| 196 | Cellulose | 100% PBAT | 75 wt% PBSA: 25 wt% PLA | 100% PBSA | 75 wt% PBSA: 25 wt% PLA |
| 197 | Cellulose | 100% PBAT | 85 wt% PBSA: 15 wt% PLA | 100% PBSA | 85 wt% PBSA: 15 wt% PLA |
| 198 | Cellulose | 100% PBAT | 50 wt% PBAT: 50 wt% PLA | 100% PBSA | 50 wt% PBAT: 50 wt% PLA |
| 199 | Cellulose | 100% PBAT | 65 wt% PBAT: 35 wt% PLA | 100% PBSA | 65 wt% PBAT: 35 wt% PLA |
| 200 | Cellulose | 100% PBAT | 75 wt% PBAT: 25 wt% PLA | 100% PBSA | 75 wt% PBAT: 25 wt% PLA |
| 201 | Cellulose | 100% PBAT | 85 wt% PBAT: 15 wt% PLA | 100% PBSA | 85 wt% PBAT: 15 wt% PLA |
| 202 | Cellulose | 100% PBAT | 50% PLA: 50% PCL | 100% PBSA | 50% PLA: 50% PCL |
| 203 | Cellulose | 100% PBAT | 60% PLA: 40% PCL | 100% PBSA | 60% PLA: 40% PCL |
| 204 | Cellulose | 100% PBAT | 70% PLA: 30% PCL | 100% PBSA | 70% PLA: 30% PCL |
| 205 | Cellulose | 100% PBAT | 80% PLA: 20% PCL | 100% PBSA | 80% PLA: 20% PCL |
| 206 | Paper | 100% PBSA | 50 wt% PBSA: 50 wt% PLA | 100% PBAT | 50 wt% PBSA: 50 wt% PLA |
| 207 | Paper | 100% PBSA | 65 wt% PBSA: 35 wt% PLA | 100% PBAT | 65 wt% PBSA: 35 wt% PLA |
| 208 | Paper | 100% PBSA | 75 wt% PBSA: 25 wt% PLA | 100% PBAT | 75 wt% PBSA: 25 wt% PLA |
| 209 | Paper | 100% PBSA | 85 wt% PBSA: 15 wt% PLA | 100% PBAT | 85 wt% PBSA: 15 wt% PLA |
| 210 | Paper | 100% PBSA | 50 wt% PBAT: 50 wt% PLA | 100% PBAT | 50 wt% PBAT: 50 wt% PLA |
| 211 | Paper | 100% PBSA | 65 wt% PBAT: 35 wt% PLA | 100% PBAT | 65 wt% PBAT: 35 wt% PLA |
| 212 | Paper | 100% PBSA | 75 wt% PBAT: 25 wt% PLA | 100% PBAT | 75 wt% PBAT: 25 wt% PLA |
| 213 | Paper | 100% PBSA | 85 wt% PBAT: 15 wt% PLA | 100% PBAT | 85 wt% PBAT: 15 wt% PLA |
| 214 | Paper | 100% PBSA | 50% PLA: 50% PCL | 100% PBAT | 50% PLA: 50% PCL |
| 215 | Paper | 100% PBSA | 60% PLA: 40% PCL | 100% PBAT | 60% PLA: 40% PCL |
| 216 | Paper | 100% PBSA | 70% PLA: 30% PCL | 100% PBAT | 70% PLA: 30% PCL |
| 217 | Paper | 100% PBSA | 80% PLA: 20% PCL | 100% PBAT | 80% PLA: 20% PCL |
| 218 | Paper | 100% PBAT | 50 wt% PBSA: 50 wt% PLA | 100% PBSA | 50 wt% PBSA: 50 wt% PLA |
| 219 | Paper | 100% PBAT | 65 wt% PBSA: 35 wt% PLA | 100% PBSA | 65 wt% PBSA: 35 wt% PLA |
| 220 | Paper | 100% PBAT | 75 wt% PBSA: 25 wt% PLA | 100% PBSA | 75 wt% PBSA: 25 wt% PLA |
| 221 | Paper | 100% PBAT | 85 wt% PBSA: 15 wt% PLA | 100% PBSA | 85 wt% PBSA: 15 wt% PLA |
| 222 | Paper | 100% PBAT | 50 wt% PBAT: 50 wt% PLA | 100% PBSA | 50 wt% PBAT: 50 wt% PLA |
| 223 | Paper | 100% PBAT | 65 wt% PBAT: 35 wt% PLA | 100% PBSA | 65 wt% PBAT: 35 wt% PLA |
| 224 | Paper | 100% PBAT | 75 wt% PBAT: 25 wt% PLA | 100% PBSA | 75 wt% PBAT: 25 wt% PLA |
| 225 | Paper | 100% PBAT | 85 wt% PBAT: 15 wt% PLA | 100% PBSA | 85 wt% PBAT: 15 wt% PLA |
| 226 | Paper | 100% PBAT | 50% PLA: 50% PCL | 100% PBSA | 50% PLA: 50% PCL |
| 227 | Paper | 100% PBAT | 60% PLA: 40% PCL | 100% PBSA | 60% PLA: 40% PCL |
| 228 | Paper | 100% PBAT | 70% PLA: 30% PCL | 100% PBSA | 70% PLA: 30% PCL |
| 229 | Paper | 100% PBAT | 80% PLA: 20% PCL | 100% PBSA | 80% PLA: 20% PCL |

### Example 5: Laminates Comprising 4 Ply Structures Wherein Sealing Sheet Is Two Layered Sheet

TABLE 5

| Sheet # | Substrate | Tie layer | Intermediate layer | Sealing sheet | |
|---|---|---|---|---|---|
| | | | | Sheet second outer layer | Outer layer |
| 230 | Cellulose | 100% PBSA | Cellulose | 100% PBAT | 50 wt% PBSA: 50 wt% PLA |
| 231 | Cellulose | 100% PBSA | Cellulose | 100% PBAT | 65 wt% PBSA: 35 wt% PLA |
| 232 | Cellulose | 100% PBSA | Cellulose | 100% PBAT | 75 wt% PBSA: 25 wt% PLA |
| 233 | Cellulose | 100% PBSA | Cellulose | 100% PBAT | 85 wt% PBSA: 15 wt% PLA |
| 234 | Cellulose | 100% PBSA | Cellulose | 100% PBAT | 50 wt% PBAT: 50 wt% PLA |
| 235 | Cellulose | 100% PBSA | Cellulose | 100% PBAT | 65 wt% PBAT: 35 wt% PLA |
| 236 | Cellulose | 100% PBSA | Cellulose | 100% PBAT | 75 wt% PBAT: 25 wt% PLA |
| 237 | Cellulose | 100% PBSA | Cellulose | 100% PBAT | 85 wt% PBAT: 15 wt% PLA |
| 238 | Cellulose | 100% PBSA | Cellulose | 100% PBAT | 50% PLA: 50% PCL |
| 239 | Cellulose | 100% PBSA | Cellulose | 100% PBAT | 60% PLA: 40% PCL |
| 240 | Cellulose | 100% PBSA | Cellulose | 100% PBAT | 70% PLA: 30% PCL |
| 241 | Cellulose | 100% PBSA | Cellulose | 100% PBAT | 80% PLA: 20% PCL |
| 242 | Cellulose | 100% PBSA | Cellulose | 100% PBSA | 50 wt% PBSA: 50 wt% PLA |
| 243 | Cellulose | 100% PBSA | Cellulose | 100% PBSA | 65 wt% PBSA: 35 wt% PLA |
| 244 | Cellulose | 100% PBSA | Cellulose | 100% PBSA | 75 wt% PBSA: 25 wt% PLA |
| 245 | Cellulose | 100% PBSA | Cellulose | 100% PBSA | 85 wt% PBSA: 15 wt% PLA |
| 246 | Cellulose | 100% PBSA | Cellulose | 100% PBSA | 50 wt% PBAT: 50 wt% PLA |
| 247 | Cellulose | 100% PBSA | Cellulose | 100% PBSA | 65 wt% PBAT: 35 wt% PLA |
| 248 | Cellulose | 100% PBSA | Cellulose | 100% PBSA | 75 wt% PBAT: 25 wt% PLA |
| 249 | Cellulose | 100% PBSA | Cellulose | 100% PBSA | 85 wt% PBAT: 15 wt% PLA |
| 250 | Cellulose | 100% PBSA | Cellulose | 100% PBSA | 50% PLA: 50% PCL |
| 251 | Cellulose | 100% PBSA | Cellulose | 100% PBSA | 60% PLA: 40% PCL |
| 252 | Cellulose | 100% PBSA | Cellulose | 100% PBSA | 70% PLA: 30% PCL |
| 253 | Cellulose | 100% PBSA | Cellulose | 100% PBSA | 80% PLA: 20% PCL |
| 254 | Cellulose | 100% PBAT | Cellulose | 100% PBAT | 50 wt% PBSA: 50 wt% PLA |
| 255 | Cellulose | 100% PBAT | Cellulose | 100% PBAT | 65 wt% PBSA: 35 wt% PLA |
| 256 | Cellulose | 100% PBAT | Cellulose | 100% PBAT | 75 wt% PBSA: 25 wt% PLA |
| 257 | Cellulose | 100% PBAT | Cellulose | 100% PBAT | 85 wt% PBSA: 15 wt% PLA |
| 258 | Cellulose | 100% PBAT | Cellulose | 100% PBAT | 50 wt% PBAT: 50 wt% PLA |
| 259 | Cellulose | 100% PBAT | Cellulose | 100% PBAT | 65 wt% PBAT: 35 wt% PLA |
| 260 | Cellulose | 100% PBAT | Cellulose | 100% PBAT | 75 wt% PBAT: 25 wt% PLA |
| 261 | Cellulose | 100% PBAT | Cellulose | 100% PBAT | 85 wt% PBAT: 15 wt% PLA |
| 262 | Cellulose | 100% PBAT | Cellulose | 100% PBAT | 50% PLA: 50% PCL |
| 263 | Cellulose | 100% PBAT | Cellulose | 100% PBAT | 60% PLA: 40% PCL |
| 264 | Cellulose | 100% PBAT | Cellulose | 100% PBAT | 70% PLA: 30% PCL |
| 265 | Cellulose | 100% PBAT | Cellulose | 100% PBAT | 80% PLA: 20% PCL |
| 266 | Cellulose | 100% PBAT | Cellulose | 100% PBSA | 50 wt% PBSA: 50 wt% PLA |
| 267 | Cellulose | 100% PBAT | Cellulose | 100% PBSA | 65 wt% PBSA: 35 wt% PLA |
| 268 | Cellulose | 100% PBAT | Cellulose | 100% PBSA | 75 wt% PBSA: 25 wt% PLA |
| 269 | Cellulose | 100% PBAT | Cellulose | 100% PBSA | 85 wt% PBSA: 15 wt% PLA |
| 270 | Cellulose | 100% PBAT | Cellulose | 100% PBSA | 50 wt% PBAT: 50 wt% PLA |
| 271 | Cellulose | 100% PBAT | Cellulose | 100% PBSA | 65 wt% PBAT: 35 wt% PLA |
| 272 | Cellulose | 100% PBAT | Cellulose | 100% PBSA | 75 wt% PBAT: 25 wt% PLA |
| 273 | Cellulose | 100% PBAT | Cellulose | 100% PBSA | 85 wt% PBAT: 15 wt% PLA |
| 274 | Cellulose | 100% PBAT | Cellulose | 100% PBSA | 50% PLA: 50% PCL |
| 275 | Cellulose | 100% PBAT | Cellulose | 100% PBSA | 60% PLA: 40% PCL |
| 276 | Cellulose | 100% PBAT | Cellulose | 100% PBSA | 70% PLA: 30% PCL |
| 277 | Cellulose | 100% PBAT | Cellulose | 100% PBSA | 80% PLA: 20% PCL |
| 278 | Paper | 100% PBSA | Cellulose | 100% PBAT | 50 wt% PBSA: 50 wt% PLA |
| 279 | Paper | 100% PBSA | Cellulose | 100% PBAT | 65 wt% PBSA: 35 wt% PLA |
| 280 | Paper | 100% PBSA | Cellulose | 100% PBAT | 75 wt% PBSA: 25 wt% PLA |
| 281 | Paper | 100% PBSA | Cellulose | 100% PBAT | 85 wt% PBSA: 15 wt% PLA |
| 282 | Paper | 100% PBSA | Cellulose | 100% PBAT | 50 wt% PBAT: 50 wt% PLA |
| 283 | Paper | 100% PBSA | Cellulose | 100% PBAT | 65 wt% PBAT: 35 wt% PLA |
| 284 | Paper | 100% PBSA | Cellulose | 100% PBAT | 75 wt% PBAT: 25 wt% PLA |
| 285 | Paper | 100% PBSA | Cellulose | 100% PBAT | 85 wt% PBAT: 15 wt% PLA |
| 286 | Paper | 100% PBSA | Cellulose | 100% PBAT | 50% PLA: 50% PCL |
| 287 | Paper | 100% PBSA | Cellulose | 100% PBAT | 60% PLA: 40% PCL |
| 288 | Paper | 100% PBSA | Cellulose | 100% PBAT | 70% PLA: 30% PCL |
| 289 | Paper | 100% PBSA | Cellulose | 100% PBAT | 80% PLA: 20% PCL |
| 290 | Paper | 100% PBSA | Cellulose | 100% PBSA | 50 wt% PBSA: 50 wt% PLA |
| 291 | Paper | 100% PBSA | Cellulose | 100% PBSA | 65 wt% PBSA: 35 wt% PLA |
| 292 | Paper | 100% PBSA | Cellulose | 100% PBSA | 75 wt% PBSA: 25 wt% PLA |
| 293 | Paper | 100% PBSA | Cellulose | 100% PBSA | 85 wt% PBSA: 15 wt% PLA |
| 294 | Paper | 100% PBSA | Cellulose | 100% PBSA | 50 wt% PBAT: 50 wt% PLA |
| 295 | Paper | 100% PBSA | Cellulose | 100% PBSA | 65 wt% PBAT: 35 wt% PLA |
| 296 | Paper | 100% PBSA | Cellulose | 100% PBSA | 75 wt% PBAT: 25 wt% PLA |
| 297 | Paper | 100% PBSA | Cellulose | 100% PBSA | 85 wt% PBAT: 15 wt% PLA |
| 298 | Paper | 100% PBSA | Cellulose | 100% PBSA | 50% PLA: 50% PCL |
| 299 | Paper | 100% PBSA | Cellulose | 100% PBSA | 60% PLA: 40% PCL |
| 300 | Paper | 100% PBSA | Cellulose | 100% PBSA | 70% PLA: 30% PCL |
| 301 | Paper | 100% PBSA | Cellulose | 100% PBSA | 80% PLA: 20% PCL |
| 302 | Paper | 100% PBAT | Cellulose | 100% PBAT | 50 wt% PBSA: 50 wt% PLA |
| 303 | Paper | 100% PBAT | Cellulose | 100% PBAT | 65 wt% PBSA: 35 wt% PLA |
| 304 | Paper | 100% PBAT | Cellulose | 100% PBAT | 75 wt% PBSA: 25 wt% PLA |
| 305 | Paper | 100% PBAT | Cellulose | 100% PBAT | 85 wt% PBSA: 15 wt% PLA |
| 307 | Paper | 100% PBAT | Cellulose | 100% PBAT | 50 wt% PBAT: 50 wt% PLA |
| 308 | Paper | 100% PBAT | Cellulose | 100% PBAT | 65 wt% PBAT: 35 wt% PLA |
| 309 | Paper | 100% PBAT | Cellulose | 100% PBAT | 75 wt% PBAT: 25 wt% PLA |
| 310 | Paper | 100% PBAT | Cellulose | 100% PBAT | 85 wt% PBAT: 15 wt% PLA |
| 311 | Paper | 100% PBAT | Cellulose | 100% PBAT | 50% PLA: 50% PCL |
| 312 | Paper | 100% PBAT | Cellulose | 100% PBAT | 60% PLA: 40% PCL |
| 313 | Paper | 100% PBAT | Cellulose | 100% PBAT | 70% PLA: 30% PCL |
| 314 | Paper | 100% PBAT | Cellulose | 100% PBAT | 80% PLA: 20% PCL |
| 315 | Paper | 100% PBAT | Cellulose | 100% PBSA | 50 wt% PBSA: 50 wt% PLA |
| 316 | Paper | 100% PBAT | Cellulose | 100% PBSA | 65 wt% PBSA: 35 wt% PLA |
| 317 | Paper | 100% PBAT | Cellulose | 100% PBSA | 75 wt% PBSA: 25 wt% PLA |
| 318 | Paper | 100% PBAT | Cellulose | 100% PBSA | 85 wt% PBSA: 15 wt% PLA |
| 319 | Paper | 100% PBAT | Cellulose | 100% PBSA | 50 wt% PBAT: 50 wt% PLA |
| 320 | Paper | 100% PBAT | Cellulose | 100% PBSA | 65 wt% PBAT: 35 wt% PLA |
| 321 | Paper | 100% PBAT | Cellulose | 100% PBSA | 75 wt% PBAT: 25 wt% PLA |
| 322 | Paper | 100% PBAT | Cellulose | 100% PBSA | 85 wt% PBAT: 15 wt% PLA |
| 323 | Paper | 100% PBAT | Cellulose | 100% PBSA | 50% PLA: 50% PCL |
| 324 | Paper | 100% PBAT | Cellulose | 100% PBSA | 60% PLA: 40% PCL |
| 325 | Paper | 100% PBAT | Cellulose | 100% PBSA | 70% PLA: 30% PCL |
| 326 | Paper | 100% PBAT | Cellulose | 100% PBSA | 80% PLA: 20% PCL |

### Example 6: Laminates Comprising 4 Ply Structures Wherein Sealing Sheet Is Three Layered Sheet

TABLE 6

| Sheet # | Substrate | Tie layer | Intermediate layer | Sealing sheet | | |
|---|---|---|---|---|---|---|
| | | | | Sheet second outer layer | Core layer | Outer layer |
| 327 | Cellulose | 100% PBSA | Cellulose | 50 wt% PBSA: 50 wt% PLA | 100% PBAT | 50 wt% PBSA: 50 wt% PLA |
| 328 | Cellulose | 100% PBSA | Cellulose | 65 wt% PBSA: 35 wt% PLA | 100% PBAT | 65 wt% PBSA: 35 wt% PLA |
| 329 | Cellulose | 100% PBSA | Cellulose | 75 wt% PBSA: 25 wt% PLA | 100% PBAT | 75 wt% PBSA: 25 wt% PLA |
| 330 | Cellulose | 100% PBSA | Cellulose | 85 wt% PBSA: 15 wt% PLA | 100% PBAT | 85 wt% PBSA: 15 wt% PLA |
| 331 | Cellulose | 100% PBSA | Cellulose | 50 wt% PBAT: 50 wt% PLA | 100% PBAT | 50 wt% PBAT: 50 wt% PLA |
| 332 | Cellulose | 100% PBSA | Cellulose | 65 wt% PBAT: 35 wt% PLA | 100% PBAT | 65 wt% PBAT: 35 wt% PLA |
| 333 | Cellulose | 100% PBSA | Cellulose | 75 wt% PBAT: 25 wt% PLA | 100% PBAT | 75 wt% PBAT: 25 wt% PLA |
| 334 | Cellulose | 100% PBSA | Cellulose | 85 wt% PBAT: 15 wt% PLA | 100% PBAT | 85 wt% PBAT: 15 wt% PLA |
| 335 | Cellulose | 100% PBSA | Cellulose | 50% PLA: 50% PCL | 100% PBAT | 50% PLA: 50% PCL |
| 336 | Cellulose | 100% PBSA | Cellulose | 60% PLA: 40% PCL | 100% PBAT | 60% PLA: 40% PCL |
| 337 | Cellulose | 100% PBSA | Cellulose | 70% PLA: 30% PCL | 100% PBAT | 70% PLA: 30% PCL |
| 338 | Cellulose | 100% PBSA | Cellulose | 80% PLA: 20% PCL | 100% PBAT | 80% PLA: 20% PCL |
| 339 | Cellulose | 100% PBSA | Cellulose | 50 wt% PBSA: 50 wt% PLA | 100% PBSA | 50 wt% PBSA: 50 wt% PLA |
| 340 | Cellulose | 100% PBSA | Cellulose | 65 wt% PBSA: 35 wt% PLA | 100% PBSA | 65 wt% PBSA: 35 wt% PLA |
| 341 | Cellulose | 100% PBSA | Cellulose | 75 wt% PBSA: 25 wt% PLA | 100% PBSA | 75 wt% PBSA: 25 wt% PLA |
| 342 | Cellulose | 100% PBSA | Cellulose | 85 wt% PBSA: 15 wt% PLA | 100% PBSA | 85 wt% PBSA: 15 wt% PLA |
| 343 | Cellulose | 100% PBSA | Cellulose | 50 wt% PBAT: 50 wt% PLA | 100% PBSA | 50 wt% PBAT: 50 wt% PLA |
| 344 | Cellulose | 100% PBSA | Cellulose | 65 wt% PBAT: 35 wt% PLA | 100% PBSA | 65 wt% PBAT: 35 wt% PLA |
| 345 | Cellulose | 100% PBSA | Cellulose | 75 wt% PBAT: 25 wt% PLA | 100% PBSA | 75 wt% PBAT: 25 wt% PLA |
| 346 | Cellulose | 100% PBSA | Cellulose | 85 wt% PBAT: 15 wt% PLA | 100% PBSA | 85 wt% PBAT: 15 wt% PLA |
| 347 | Cellulose | 100% PBSA | Cellulose | 50% PLA: 50% PCL | 100% PBSA | 50% PLA: 50% PCL |
| 348 | Cellulose | 100% PBSA | Cellulose | 60% PLA: 40% PCL | 100% PBSA | 60% PLA: 40% PCL |
| 349 | Cellulose | 100% PBSA | Cellulose | 70% PLA: 30% PCL | 100% PBSA | 70% PLA: 30% PCL |
| 350 | Cellulose | 100% PBSA | Cellulose | 80% PLA: 20% PCL | 100% PBSA | 80% PLA: 20% PCL |
| 351 | Cellulose | 100% PBAT | Cellulose | 50 wt% PBSA: 50 wt% PLA | 100% PBAT | 50 wt% PBSA: 50 wt% PLA |
| 352 | Cellulose | 100% PBAT | Cellulose | 65 wt% PBSA: 35 wt% PLA | 100% PBAT | 65 wt% PBSA: 35 wt% PLA |
| 353 | Cellulose | 100% PBAT | Cellulose | 75 wt% PBSA: 25 wt% PLA | 100% PBAT | 75 wt% PBSA: 25 wt% PLA |
| 354 | Cellulose | 100% PBAT | Cellulose | 85 wt% PBSA: 15 wt% PLA | 100% PBAT | 85 wt% PBSA: 15 wt% PLA |
| 355 | Cellulose | 100% PBAT | Cellulose | 50 wt% PBAT: 50 wt% PLA | 100% PBAT | 50 wt% PBAT: 50 wt% PLA |
| 356 | Cellulose | 100% PBAT | Cellulose | 65 wt% PBAT: 35 wt% PLA | 100% PBAT | 65 wt% PBAT: 35 wt% PLA |
| 357 | Cellulose | 100% PBAT | Cellulose | 75 wt% PBAT: 25 wt% PLA | 100% PBAT | 75 wt% PBAT: 25 wt% PLA |
| 358 | Cellulose | 100% PBAT | Cellulose | 85 wt% PBAT: 15 wt% PLA | 100% PBAT | 85 wt% PBAT: 15 wt% PLA |
| 359 | Cellulose | 100% PBAT | Cellulose | 50% PLA: 50% PCL | 100% PBAT | 50% PLA: 50% PCL |
| 360 | Cellulose | 100% PBAT | Cellulose | 60% PLA: 40% PCL | 100% PBAT | 60% PLA: 40% PCL |
| 361 | Cellulose | 100% PBAT | Cellulose | 70% PLA: 30% PCL | 100% PBAT | 70% PLA: 30% PCL |
| 362 | Cellulose | 100% PBAT | Cellulose | 80% PLA: 20% PCL | 100% PBAT | 80% PLA: 20% PCL |
| 363 | Cellulose | 100% PBAT | Cellulose | 50 wt% PBSA: 50 wt% PLA | 100% PBSA | 50 wt% PBSA: 50 wt% PLA |
| 364 | Cellulose | 100% PBAT | Cellulose | 65 wt% PBSA: 35 wt% PLA | 100% PBSA | 65 wt% PBSA: 35 wt% PLA |
| 365 | Cellulose | 100% PBAT | Cellulose | 75 wt% PBSA: 25 wt% PLA | 100% PBSA | 75 wt% PBSA: 25 wt% PLA |
| 366 | Cellulose | 100% PBAT | Cellulose | 85 wt% PBSA: 15 wt% PLA | 100% PBSA | 85 wt% PBSA: 15 wt% PLA |
| 367 | Cellulose | 100% PBAT | Cellulose | 50 wt% PBAT: 50 wt% PLA | 100% PBSA | 50 wt% PBAT: 50 wt% PLA |
| 368 | Cellulose | 100% PBAT | Cellulose | 65 wt% PBAT: 35 wt% PLA | 100% PBSA | 65 wt% PBAT: 35 wt% PLA |
| 369 | Cellulose | 100% PBAT | Cellulose | 75 wt% PBAT: 25 wt% PLA | 100% PBSA | 75 wt% PBAT: 25 wt% PLA |
| 370 | Cellulose | 100% PBAT | Cellulose | 85 wt% PBAT: 15 wt% PLA | 100% PBSA | 85 wt% PBAT: 15 wt% PLA |
| 371 | Cellulose | 100% PBAT | Cellulose | 50% PLA: 50% PCL | 100% PBSA | 50% PLA: 50% PCL |
| 372 | Cellulose | 100% PBAT | Cellulose | 60% PLA: 40% PCL | 100% PBSA | 60% PLA: 40% PCL |
| 373 | Cellulose | 100% PBAT | Cellulose | 70% PLA: 30% PCL | 100% PBSA | 70% PLA: 30% PCL |
| 374 | Cellulose | 100% PBAT | Cellulose | 80% PLA: 20% PCL | 100% PBSA | 80% PLA: 20% PCL |
| 375 | Paper | 100% PBSA | Cellulose | 50 wt% PBSA: 50 wt% PLA | 100% PBAT | 50 wt% PBSA: 50 wt% PLA |
| 376 | Paper | 100% PBSA | Cellulose | 65 wt% PBSA: 35 wt% PLA | 100% PBAT | 65 wt% PBSA: 35 wt% PLA |
| 377 | Paper | 100% PBSA | Cellulose | 75 wt% PBSA: 25 wt% PLA | 100% PBAT | 75 wt% PBSA: 25 wt% PLA |
| 378 | Paper | 100% PBSA | Cellulose | 85 wt% PBSA: 15 wt% PLA | 100% PBAT | 85 wt% PBSA: 15 wt% PLA |
| 379 | Paper | 100% PBSA | Cellulose | 50 wt% PBAT: 50 wt% PLA | 100% PBAT | 50 wt% PBAT: 50 wt% PLA |
| 380 | Paper | 100% PBSA | Cellulose | 65 wt% PBAT: 35 wt% PLA | 100% PBAT | 65 wt% PBAT: 35 wt% PLA |
| 381 | Paper | 100% PBSA | Cellulose | 75 wt% PBAT: 25 wt% PLA | 100% PBAT | 75 wt% PBAT: 25 wt% PLA |
| 382 | Paper | 100% PBSA | Cellulose | 85 wt% PBAT: 15 wt% PLA | 100% PBAT | 85 wt% PBAT: 15 wt% PLA |
| 383 | Paper | 100% PBSA | Cellulose | 50% PLA: 50% PCL | 100% PBAT | 50% PLA: 50% PCL |
| 384 | Paper | 100% PBSA | Cellulose | 60% PLA: 40% PCL | 100% PBAT | 60% PLA: 40% PCL |
| 385 | Paper | 100% PBSA | Cellulose | 70% PLA: 30% PCL | 100% PBAT | 70% PLA: 30% PCL |
| 386 | Paper | 100% PBSA | Cellulose | 80% PLA: 20% PCL | 100% PBAT | 80% PLA: 20% PCL |
| 387 | Paper | 100% PBSA | Cellulose | 50 wt% PBSA: 50 wt% PLA | 100% PBSA | 50 wt% PBSA: 50 wt% PLA |
| 388 | Paper | 100% PBSA | Cellulose | 65 wt% PBSA: 35 wt% PLA | 100% PBSA | 65 wt% PBSA: 35 wt% PLA |
| 389 | Paper | 100% PBSA | Cellulose | 75 wt% PBSA: 25 wt% PLA | 100% PBSA | 75 wt% PBSA: 25 wt% PLA |
| 390 | Paper | 100% PBSA | Cellulose | 85 wt% PBSA: 15 wt% PLA | 100% PBSA | 85 wt% PBSA: 15 wt% PLA |
| 391 | Paper | 100% PBSA | Cellulose | 50 wt% PBAT: 50 wt% PLA | 100% PBSA | 50 wt% PBAT: 50 wt% PLA |
| 392 | Paper | 100% PBSA | Cellulose | 65 wt% PBAT: 35 wt% PLA | 100% PBSA | 65 wt% PBAT: 35 wt% PLA |
| 393 | Paper | 100% PBSA | Cellulose | 75 wt% PBAT: 25 wt% PLA | 100% PBSA | 75 wt% PBAT: 25 wt% PLA |
| 394 | Paper | 100% PBSA | Cellulose | 85 wt% PBAT: 15 wt% PLA | 100% PBSA | 85 wt% PBAT: 15 wt% PLA |
| 395 | Paper | 100% PBSA | Cellulose | 50% PLA: 50% PCL | 100% PBSA | 50% PLA: 50% PCL |
| 396 | Paper | 100% PBSA | Cellulose | 60% PLA: 40% PCL | 100% PBSA | 60% PLA: 40% PCL |
| 397 | Paper | 100% PBSA | Cellulose | 70% PLA: 30% PCL | 100% PBSA | 70% PLA: 30% PCL |
| 398 | Paper | 100% PBSA | Cellulose | 80% PLA: 20% PCL | 100% PBSA | 80% PLA: 20% PCL |
| 399 | Paper | 100% PBAT | Cellulose | 50 wt% PBSA: 50 wt% PLA | 100% PBAT | 50 wt% PBSA: 50 wt% PLA |
| 400 | Paper | 100% PBAT | Cellulose | 65 wt% PBSA: 35 wt% PLA | 100% PBAT | 65 wt% PBSA: 35 wt% PLA |
| 401 | Paper | 100% PBAT | Cellulose | 75 wt% PBSA: 25 wt% PLA | 100% PBAT | 75 wt% PBSA: 25 wt% PLA |
| 402 | Paper | 100% PBAT | Cellulose | 85 wt% PBSA: 15 wt% PLA | 100% PBAT | 85 wt% PBSA: 15 wt% PLA |
| 403 | Paper | 100% PBAT | Cellulose | 50 wt% PBAT: 50 wt% PLA | 100% PBAT | 50 wt% PBAT: 50 wt% PLA |
| 404 | Paper | 100% PBAT | Cellulose | 65 wt% PBAT: 35 wt% PLA | 100% PBAT | 65 wt% PBAT: 35 wt% PLA |
| 405 | Paper | 100% PBAT | Cellulose | 75 wt% PBAT: 25 wt% PLA | 100% PBAT | 75 wt% PBAT: 25 wt% PLA |
| 406 | Paper | 100% PBAT | Cellulose | 85 wt% PBAT: 15 wt% PLA | 100% PBAT | 85 wt% PBAT: 15 wt% PLA |
| 407 | Paper | 100% PBAT | Cellulose | 50% PLA: 50% PCL | 100% PBAT | 50% PLA: 50% PCL |
| 408 | Paper | 100% PBAT | Cellulose | 60% PLA: 40% PCL | 100% PBAT | 60% PLA: 40% PCL |
| 409 | Paper | 100% PBAT | Cellulose | 70% PLA: 30% PCL | 100% PBAT | 70% PLA: 30% PCL |
| 410 | Paper | 100% PBAT | Cellulose | 80% PLA: 20% PCL | 100% PBAT | 80% PLA: 20% PCL |
| 411 | Paper | 100% PBAT | Cellulose | 50 wt% PBSA: 50 wt% PLA | 100% PBSA | 50 wt% PBSA: 50 wt% PLA |
| 412 | Paper | 100% PBAT | Cellulose | 65 wt% PBSA: 35 wt% PLA | 100% PBSA | 65 wt% PBSA: 35 wt% PLA |
| 413 | Paper | 100% PBAT | Cellulose | 75 wt% PBSA: 25 wt% PLA | 100% PBSA | 75 wt% PBSA: 25 wt% PLA |
| 414 | Paper | 100% PBAT | Cellulose | 85 wt% PBSA: 15 wt% PLA | 100% PBSA | 85 wt% PBSA: 15 wt% PLA |
| 415 | Paper | 100% PBAT | Cellulose | 50 wt% PBAT: 50 wt% PLA | 100% PBSA | 50 wt% PBAT: 50 wt% PLA |
| 416 | Paper | 100% PBAT | Cellulose | 65 wt% PBAT: 35 wt% PLA | 100% PBSA | 65 wt% PBAT: 35 wt% PLA |
| 417 | Paper | 100% PBAT | Cellulose | 75 wt% PBAT: 25 wt% PLA | 100% PBSA | 75 wt% PBAT: 25 wt% PLA |
| 418 | Paper | 100% PBAT | Cellulose | 85 wt% PBAT: 15 wt% PLA | 100% PBSA | 85 wt% PBAT: 15 wt% PLA |
| 419 | Paper | 100% PBAT | Cellulose | 50% PLA: 50% PCL | 100% PBSA | 50% PLA: 50% PCL |
| 420 | Paper | 100% PBAT | Cellulose | 60% PLA: 40% PCL | 100% PBSA | 60% PLA: 40% PCL |
| 421 | Paper | 100% PBAT | Cellulose | 70% PLA: 30% PCL | 100% PBSA | 70% PLA: 30% PCL |
| 422 | Paper | 100% PBAT | Cellulose | 80% PLA: 20% PCL | 100% PBSA | 80% PLA: 20% PCL |

### Example 7: Laminates Comprising 5 Ply Structures Wherein Sealing Sheet Is Three Layered Sheet

TABLE 7

| Sheet # | Substrate | First tie layer | Intermediate layer | Second tie layer | Sealing sheet | | |
|---|---|---|---|---|---|---|---|
| | | | | | Sheet second outer layer | Core layer | Sheet outer layer |
| 423 | Cellulose | 100% PBSA | Cellulose | 100% PBSA | 50 wt% PBSA: 50 wt% PLA | 100% PBAT | 50 wt% PBSA: 50 wt% PLA |
| 424 | Cellulose | 100% PBSA | Cellulose | 100% PBSA | 65 wt% PBSA: 35 wt% PLA | 100% PBAT | 65 wt% PBSA: 35 wt% PLA |
| 425 | Cellulose | 100% PBSA | Cellulose | 100% PBSA | 75 wt% PBSA: 25 wt% PLA | 100% PBAT | 75 wt% PBSA: 25 wt% PLA |
| 426 | Cellulose | 100% PBSA | Cellulose | 100% PBSA | 85 wt% PBSA: 15 wt% PLA | 100% PBAT | 85 wt% PBSA: 15 wt% PLA |
| 427 | Cellulose | 100% PBSA | Cellulose | 100% PBSA | 50 wt% PBAT: 50 wt% PLA | 100% PBAT | 50 wt% PBAT: 50 wt% PLA |
| 428 | Cellulose | 100% PBSA | Cellulose | 100% PBSA | 65 wt% PBAT: 35 wt% PLA | 100% PBAT | 65 wt% PBAT: 35 wt% PLA |
| 429 | Cellulose | 100% PBSA | Cellulose | 100% PBSA | 75 wt% PBAT: 25 wt% PLA | 100% PBAT | 75 wt% PBAT: 25 wt% PLA |
| 430 | Cellulose | 100% PBSA | Cellulose | 100% PBSA | 85 wt% PBAT: 15 wt% PLA | 100% PBAT | 85 wt% PBAT: 15 wt% PLA |
| 431 | Cellulose | 100% PBSA | Cellulose | 100% PBSA | 50% PLA: 50% PCL | 100% PBAT | 50% PLA: 50% PCL |
| 432 | Cellulose | 100% PBSA | Cellulose | 100% PBSA | 60% PLA: 40% PCL | 100% PBAT | 60% PLA: 40% PCL |
| 433 | Cellulose | 100% PBSA | Cellulose | 100% PBSA | 70% PLA: 30% PCL | 100% PBAT | 70% PLA: 30% PCL |
| 434 | Cellulose | 100% PBSA | Cellulose | 100% PBSA | 80% PLA: 20% PCL | 100% PBAT | 80% PLA: 20% PCL |
| 435 | Cellulose | 100% PBSA | Cellulose | 100% PBAT | 50 wt% PBSA: 50 wt% PLA | 100% PBAT | 50 wt% PBSA: 50 wt% PLA |
| 436 | Cellulose | 100% PBSA | Cellulose | 100% PBAT | 65 wt% PBSA: 35 wt% PLA | 100% PBAT | 65 wt% PBSA: 35 wt% PLA |
| 437 | Cellulose | 100% PBSA | Cellulose | 100% PBAT | 75 wt% PBSA: | 100% PBAT | 75 wt% PBSA: |
| | | | | | 25 wt% PLA | | 25 wt% PLA |
| 438 | Cellulose | 100% PBSA | Cellulose | 100% PBAT | 85 wt% PBSA: 15 wt% PLA | 100% PBAT | 85 wt% PBSA: 15 wt% PLA |
| 439 | Cellulose | 100% PBSA | Cellulose | 100% PBAT | 50 wt% PBAT: 50 wt% PLA | 100% PBAT | 50 wt% PBAT: 50 wt% PLA |
| 440 | Cellulose | 100% PBSA | Cellulose | 100% PBAT | 65 wt% PBAT: 35 wt% PLA | 100% PBAT | 65 wt% PBAT: 35 wt% PLA |
| 441 | Cellulose | 100% PBSA | Cellulose | 100% PBAT | 75 wt% PBAT: 25 wt% PLA | 100% PBAT | 75 wt% PBAT: 25 wt% PLA |
| 442 | Cellulose | 100% PBSA | Cellulose | 100% PBAT | 85 wt% PBAT: 15 wt% PLA | 100% PBAT | 85 wt% PBAT: 15 wt% PLA |
| 443 | Cellulose | 100% PBSA | Cellulose | 100% PBAT | 50% PLA: 50% PCL | 100% PBAT | 50% PLA: 50% PCL |
| 444 | Cellulose | 100% PBSA | Cellulose | 100% PBAT | 60% PLA: 40% PCL | 100% PBAT | 60% PLA: 40% PCL |
| 445 | Cellulose | 100% PBSA | Cellulose | 100% PBAT | 70% PLA: 30% PCL | 100% PBAT | 70% PLA: 30% PCL |
| 446 | Cellulose | 100% PBSA | Cellulose | 100% PBAT | 80% PLA: 20% PCL | 100% PBAT | 80% PLA: 20% PCL |
| 447 | Cellulose | 100% PBAT | Cellulose | 100% PBSA | 50 wt% PBSA: 50 wt% PLA | 100% PBAT | 50 wt% PBSA: 50 wt% PLA |
| 448 | Cellulose | 100% PBAT | Cellulose | 100% PBSA | 65 wt% PBSA: 35 wt% PLA | 100% PBAT | 65 wt% PBSA: 35 wt% PLA |
| 449 | Cellulose | 100% PBAT | Cellulose | 100% PBSA | 75 wt% PBSA: 25 wt% PLA | 100% PBAT | 75 wt% PBSA: 25 wt% PLA |
| 450 | Cellulose | 100% PBAT | Cellulose | 100% PBSA | 85 wt% PBSA: 15 wt% PLA | 100% PBAT | 85 wt% PBSA: 15 wt% PLA |
| 451 | Cellulose | 100% PBAT | Cellulose | 100% PBSA | 50 wt% PBAT: 50 wt% PLA | 100% PBAT | 50 wt% PBAT: 50 wt% PLA |
| 452 | Cellulose | 100% PBAT | Cellulose | 100% PBSA | 65 wt% PBAT: 35 wt% PLA | 100% PBAT | 65 wt% PBAT: 35 wt% PLA |
| 453 | Cellulose | 100% PBAT | Cellulose | 100% PBSA | 75 wt% PBAT: 25 wt% PLA | 100% PBAT | 75 wt% PBAT: 25 wt% PLA |
| 454 | Cellulose | 100% PBAT | Cellulose | 100% PBSA | 85 wt% PBAT: 15 wt% PLA | 100% PBAT | 85 wt% PBAT: 15 wt% PLA |
| 455 | Cellulose | 100% PBAT | Cellulose | 100% PBSA | 50% PLA: 50% PCL | 100% PBAT | 50% PLA: 50% PCL |
| 456 | Cellulose | 100% PBAT | Cellulose | 100% PBSA | 60% PLA: 457.040% PCL | 100% PBAT | 60% PLA: 40% PCL |
| 457 | Cellulose | 100% PBAT | Cellulose | 100% PBSA | 70% PLA: 30% PCL | 100% PBAT | 70% PLA: 30% PCL |
| 458 | Cellulose | 100% PBAT | Cellulose | 100% PBSA | 80% PLA: 20% PCL | 100% PBAT | 80% PLA: 20% PCL |
| 459 | Cellulose | 100% PBAT | Cellulose | 100% PBAT | 50 wt% PBSA: 50 wt% PLA | 100% PBAT | 50 wt% PBSA: 50 wt% PLA |
| 460 | Cellulose | 100% PBAT | Cellulose | 100% PBAT | 65 wt% PBSA: 35 wt% PLA | 100% PBAT | 65 wt% PBSA: 35 wt% PLA |
| 461 | Cellulose | 100% PBAT | Cellulose | 100% PBAT | 75 wt% PBSA: 25 wt% PLA | 100% PBAT | 75 wt% PBSA: 25 wt% PLA |
| 462 | Cellulose | 100% PBAT | Cellulose | 100% PBAT | 85 wt% PBSA: 15 wt% PLA | 100% PBAT | 85 wt% PBSA: 15 wt% PLA |
| 463 | Cellulose | 100% PBAT | Cellulose | 100% PBAT | 50 wt% PBAT: 50 wt% PLA | 100% PBAT | 50 wt% PBAT: 50 wt% PLA |
| 464 | Cellulose | 100% PBAT | Cellulose | 100% PBAT | 65 wt% PBAT: 35 wt% PLA | 100% PBAT | 65 wt% PBAT: 35 wt% PLA |
| 465 | Cellulose | 100% PBAT | Cellulose | 100% PBAT | 75 wt% PBAT: 25 wt% PLA | 100% PBAT | 75 wt% PBAT: 25 wt% PLA |
| 466 | Cellulose | 100% PBAT | Cellulose | 100% PBAT | 85 wt% PBAT: | 100% PBAT | 85 wt% PBAT: |
| | | | | | 15 wt% PLA | | 15 wt% PLA |
| 467 | Cellulose | 100% PBAT | Cellulose | 100% PBAT | 50% PLA: 50% PCL | 100% PBAT | 50% PLA: 50% PCL |
| 468 | Cellulose | 100% PBAT | Cellulose | 100% PBAT | 60% PLA: 40% PCL | 100% PBAT | 60% PLA: 40% PCL |
| 469 | Cellulose | 100% PBAT | Cellulose | 100% PBAT | 70% PLA: 30% PCL | 100% PBAT | 70% PLA: 30% PCL |
| 470 | Cellulose | 100% PBAT | Cellulose | 100% PBAT | 80% PLA: 20% PCL | 100% PBAT | 80% PLA: 20% PCL |
| 471 | Paper | 100% PBSA | Cellulose | 100% PBSA | 50 wt% PBSA: 50 wt% PLA | 100% PBAT | 50 wt% PBSA: 50 wt% PLA |
| 472 | 0Paper | 100% PBSA | Cellulose | 100% PBSA | 65 wt% PBSA: 35 wt% PLA | 100% PBAT | 65 wt% PBSA: 35 wt% PLA |
| 473 | Paper | 100% PBSA | Cellulose | 100% PBSA | 75 wt% PBSA: 25 wt% PLA | 100% PBAT | 75 wt% PBSA: 25 wt% PLA |
| 474 | Paper | 100% PBSA | Cellulose | 100% PBSA | 85 wt% PBSA: 15 wt% PLA | 100% PBAT | 85 wt% PBSA: 15 wt% PLA |
| 475 | Paper | 100% PBSA | Cellulose | 100% PBSA | 50 wt% PBAT: 50 wt% PLA | 100% PBAT | 50 wt% PBAT: 50 wt% PLA |
| 476 | Paper | 100% PBSA | Cellulose | 100% PBSA | 65 wt% PBAT: 35 wt% PLA | 100% PBAT | 65 wt% PBAT: 35 wt% PLA |
| 477 | Paper | 100% PBSA | Cellulose | 100% PBSA | 75 wt% PBAT: 25 wt% PLA | 100% PBAT | 75 wt% PBAT: 25 wt% PLA |
| 478 | Paper | 100% PBSA | Cellulose | 100% PBSA | 85 wt% PBAT: 15 wt% PLA | 100% PBAT | 85 wt% PBAT: 15 wt% PLA |
| 479 | Paper | 100% PBSA | Cellulose | 100% PBSA | 50% PLA: 50% PCL | 100% PBAT | 50% PLA: 50% PCL |
| 480 | Paper | 100% PBSA | Cellulose | 100% PBSA | 60% PLA: 40% PCL | 100% PBAT | 60% PLA: 40% PCL |
| 481 | Paper | 100% PBSA | Cellulose | 100% PBSA | 70% PLA: 30% PCL | 100% PBAT | 70% PLA: |
| | | | | | | | 30% PCL |
| 482 | Paper | 100% PBSA | Cellulose | 100% PBSA | 80% PLA: 20% PCL | 100% PBAT | 80% PLA: 20% PCL |
| 483 | Paper | 100% PBSA | Cellulose | 100% PBAT | 50 wt% PBSA: 50 wt% PLA | 100% PBAT | 50 wt% PBSA: 50 wt% PLA |
| 484 | Paper | 100% PBSA | Cellulose | 100% PBAT | 65 wt% PBSA: 35 wt% PLA | 100% PBAT | 65 wt% PBSA: 35 wt% PLA |
| 485 | Paper | 100% PBSA | Cellulose | 100% PBAT | 75 wt% PBSA: 25 wt% PLA | 100% PBAT | 75 wt% PBSA: 25 wt% PLA |
| 486 | Paper | 100% PBSA | Cellulose | 100% PBAT | 85 wt% PBSA: 15 wt% PLA | 100% PBAT | 85 wt% PBSA: 15 wt% PLA |
| 487 | Paper | 100% PBSA | Cellulose | 100% PBAT | 50 wt% PBAT: 50 wt% PLA | 100% PBAT | 50 wt% PBAT: 50 wt% PLA |
| 488 | Paper | 100% PBSA | Cellulose | 100% PBAT | 65 wt% PBAT: 35 wt% PLA | 100% PBAT | 65 wt% PBAT: 35 wt% PLA |
| 489 | Paper | 100% PBSA | Cellulose | 100% PBAT | 75 wt% PBAT: 25 wt% PLA | 100% PBAT | 75 wt% PBAT: 25 wt% PLA |
| 490 | Paper | 100% PBSA | Cellulose | 100% PBAT | 85 wt% PBAT: 15 wt% PLA | 100% PBAT | 85 wt% PBAT: 15 wt% PLA |
| 491 | Paper | 100% PBSA | Cellulose | 100% PBAT | 50% PLA: 50% PCL | 100% PBAT | 50% PLA: 50% PCL |
| 492 | Paper | 100% PBSA | Cellulose | 100% PBAT | 60% PLA: 40% PCL | 100% PBAT | 60% PLA: 40% PCL |
| 493 | Paper | 100% PBSA | Cellulose | 100% PBAT | 70% PLA: 30% PCL | 100% PBAT | 70% PLA: 30% PCL |
| 494 | Paper | 100% PBSA | Cellulose | 100% PBAT | 80% PLA: 20% PCL | 100% PBAT | 80% PLA: 20% PCL |
| 495 | Paper | 100% PBAT | Cellulose | 100% PBSA | 50 wt% PBSA: 50 wt% PLA | 100% PBAT | 50 wt% PBSA: 50 wt% PLA |
| 496 | Paper | 100% PBAT | Cellulose | 100% PBSA | 65 wt% PBSA: | 100% PBAT | 65 wt% PBSA: |
| | | | | | 35 wt% PLA | | 35 wt% PLA |
| 497 | Paper | 100% PBAT | Cellulose | 100% PBSA | 75 wt% PBSA: 25 wt% PLA | 100% PBAT | 75 wt% PBSA: 25 wt% PLA |
| 498 | Paper | 100% PBAT | Cellulose | 100% PBSA | 85 wt% PBSA: 15 wt% PLA | 100% PBAT | 85 wt% PBSA: 15 wt% PLA |
| 499 | Paper | 100% PBAT | Cellulose | 100% PBSA | 50 wt% PBAT: 50 wt% PLA | 100% PBAT | 50 wt% PBAT: 50 wt% PLA |
| 500 | Paper | 100% PBAT | Cellulose | 100% PBSA | 65 wt% PBAT: 35 wt% PLA | 100% PBAT | 65 wt% PBAT: 35 wt% PLA |
| 501 | Paper | 100% PBAT | Cellulose | 100% PBSA | 75 wt% PBAT: 25 wt% PLA | 100% PBAT | 75 wt% PBAT: 25 wt% PLA |
| 502 | Paper | 100% PBAT | Cellulose | 100% PBSA | 85 wt% PBAT: 15 wt% PLA | 100% PBAT | 85 wt% PBAT: 15 wt% PLA |
| 503 | Paper | 100% PBAT | Cellulose | 100% PBSA | 50% PLA: 50% PCL | 100% PBAT | 50% PLA: 50% PCL |
| 504 | Paper | 100% PBAT | Cellulose | 100% PBSA | 60% PLA: 40% PCL | 100% PBAT | 60% PLA: 40% PCL |
| 505 | Paper | 100% PBAT | Cellulose | 100% PBSA | 70% PLA: 30% PCL | 100% PBAT | 70% PLA: 30% PCL |
| 506 | Paper | 100% PBAT | Cellulose | 100% PBSA | 80% PLA: 20% PCL | 100% PBAT | 80% PLA: 20% PCL |
| 507 | Paper | 100% PBAT | Cellulose | 100% PBAT | 50 wt% PBSA: 50 wt% PLA | 100% PBAT | 50 wt% PBSA: 50 wt% PLA |
| 508 | Paper | 100% PBAT | Cellulose | 100% PBAT | 65 wt% PBSA: 35 wt% PLA | 100% PBAT | 65 wt% PBSA: 35 wt% PLA |
| 509 | Paper | 100% PBAT | Cellulose | 100% PBAT | 75 wt% PBSA: 25 wt% PLA | 100% PBAT | 75 wt% PBSA: 25 wt% PLA |
| 510 | Paper | 100% PBAT | Cellulose | 100% PBAT | 85 wt% PBSA: 15 wt% PLA | 100% PBAT | 85 wt% PBSA: 15 wt% PLA |
| 511 | Paper | 100% PBAT | Cellulose | 100% PBAT | 50 wt% PBAT: 50 wt% PLA | 100% PBAT | 50 wt% PBAT: 50 wt% PLA |
| 512 | Paper | 100% PBAT | Cellulose | 100% PBAT | 65 wt% PBAT: 35 wt% PLA | 100% PBAT | 65 wt% PBAT: 35 wt% PLA |
| 513 | Paper | 100% PBAT | Cellulose | 100% PBAT | 75 wt% PBAT: 25 wt% PLA | 100% PBAT | 75 wt% PBAT: 25 wt% PLA |
| 514 | Paper | 100% PBAT | Cellulose | 100% PBAT | 85 wt% PBAT: 15 wt% PLA | 100% PBAT | 85 wt% PBAT: 15 wt% PLA |
| 515 | Paper | 100% PBAT | Cellulose | 100% PBAT | 50% PLA: 50% PCL | 100% PBAT | 50% PLA: 50% PCL |
| 516 | Paper | 100% PBAT | Cellulose | 100% PBAT | 60% PLA: 40% PCL | 100% PBAT | 60% PLA: 40% PCL |
| 517 | Paper | 100% PBAT | Cellulose | 100% PBAT | 70% PLA: 30% PCL | 100% PBAT | 70% PLA: 30% PCL |
| 518 | Paper | 100% PBAT | Cellulose | 100% PBAT | 80% PLA: 20% PCL | 100% PBAT | 80% PLA: 20% PCL |

### Example 8: Physical Properties of an Exemplary 4 Ply Structure

Sheet #354 as defined in Table 6 of Example 6 above was prepared as described in the Materials and Methods section above.

A first control sheet (Control-1) was prepared in which the first and the second tie layer was replaced by a commercial adhesive available under the name Morchem PS 255 ECO + CS-95 from Morchem Ltd., (Barcelona, Spain), and a second tie layer identical to the first tie layer was required between the intermediate layer and the sealing sheet, as shown in Table 8.

TABLE 8

| Sheet # | Substrate | Tie layer | Intermediate layer | Second tie layer | Sealing sheet | | |
|---|---|---|---|---|---|---|---|
| | | | | | Sheet second outer layer | Core layer | Outer layer |
| 354 | Cellulose | 100% PBAT | Cellulose | N/A | 85 wt% PBSA: 15 wt% PLA | 100% PBAT | 85 wt% PBSA: 15 wt% PLA |
| Control-1 | Cellulose | 100% PS 255 ECO /CS-95 | Cellulose | 100% PS 255 ECO /CS-95 | 85 wt% PBSA: 15 wt% PLA | 100% PBAT | 85 wt% PBSA: 15 wt% PLA |

In order to define the physical properties of the biodegradable sheets, Young’s Modulus and strain at break were measured using the ASTM D882 Standard Test Method for Tensile Properties of Thin Plastic Sheeting in machine direction and transverse direction.

Results are presented in Table 9 below.

TABLE 9

| Sheet # | Young’s Modulus (Mpa) - MD | Percentage Strain at Break (%)- MD | Young’s Modulus (Mpa) -TD | Percentage Strain at Break (%)- TD |
|---|---|---|---|---|
| 354 | 2653 | 19 | 1536 | 69 |
| Control-1 | 3663 | 19 | 2033 | 20 |

As seen in Table 9, sheet #354 shows a higher Young’s Modulus in both machine- and transverse-directions as well as higher percentage at break in transverse direction as compared to the control sheet, resulting in a laminate which is less brittle, more flexible and having noise reduction.

### Example 9: Sealing Properties of an Exemplary 5 Ply Structure

Sheet #510 as defined in Table 7 of Example 7 above was prepared as described in the Materials and Methods section above.

A second control sheet (Control-2) was prepared in which the second tie layer was replaced by a commercial adhesive available from Morchem Ltd., as shown in Table 10.

TABLE 10

| Sheet # | Substrate | Tie layer | Intermediate layer | Second tie layer | Sealing sheet | | |
|---|---|---|---|---|---|---|---|
| | | | | | Sheet second outer layer | Core layer | Outer layer |
| 510 | Paper | 100% PBAT | Cellulose | 100% PBAT | 85 wt% PBSA: 15 wt% PLA | 100% PBAT | 85 wt% PBSA: 15 wt% PLA |
| Control-2 | Paper | 100% PS 255 ECO /CS-95 | Cellulose | 100% PS 255 ECO /CS-95 | 85 wt% PBSA: 15 wt% PLA | 100% PBAT | 85 wt% PBSA: 15 wt% PLA |

In order to define the adhesive strengths between the biodegradable sheets in the laminate, peel resistance was measured using the ASTM D1876 Standard Test Method for Peel Resistance of Adhesives (T-Peel Test).

Results are presented in Table 11 below.

TABLE 11

| Sheet # | Peel Test (gf/inch) |
|---|---|
| 510 | 810 |
| Control-2 | 510 |

As seen in Table 11, sheet #510 shows a 59% increase in bond strength as compared to the control sheet.

The inventions illustratively described herein may suitably be practiced in the absence of any element or elements, limitation or limitations, not specifically disclosed herein. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

Although the above examples have illustrated particular ways of carrying out embodiments of the invention, in practice persons skilled in the art will appreciate alternative ways of carrying out embodiments of the invention, which are not shown explicitly herein. It should be understood that the present disclosure is to be considered as an exemplification of the principles of this invention and is not intended to limit the invention to the embodiments illustrated.

Those skilled in the art will recognize or be able to ascertain using no more than routine experimentation, equivalents of the specific embodiments of the invention described herein. Such equivalents are intended to be encompassed by the following claims.

1. A biodegradable laminated structure comprising a substrate and a tie layer, wherein said tie layer comprises a polymer selected from the group consisting of PBSA, PBS, PBAT and a mixture of PCL with PLA and combinations thereof.

2. The biodegradable laminated structure of claim 1, wherein said substrate is selected from the group consisting of paper, cellulose and combinations thereof.

3. The biodegradable laminated structure of claim 1, wherein the structure is a 2 ply structure consisting of said substrate and said tie layer.

4-6. (canceled)

7. The biodegradable laminated structure of claim 1, wherein the structure is a 3 ply structure consisting of said substrate; a sealing sheet comprising a sealing sheet outer layer and a sealing sheet second outer layer; and a tie layer provided between said substrate and said sealing sheet.

8-9. (canceled)

10. The biodegradable laminated structure of claim 1, wherein the structure is a 4 ply structure consisting of said substrate, a sealing sheet, an intermediate layer provided on said sealing sheet, and a tie layer provided between said substrate and said intermediate layer.

11. (canceled)

12. The biodegradable laminated structure of claim 1, wherein the structure is a 5 ply structure consisting of said substrate, a first tie layer provided on said substrate, a sealing sheet, a second tie layer provided on said sealing sheet, and an intermediate layer provided between said first tie layer and said second tie layer.

13. (canceled)

14. The biodegradable laminated structure claim 1, wherein said tie layer comprises PBSA and further comprises PLA.

15. The biodegradable laminated structure of claim 14, wherein said tie layer comprises from 65 wt% to 85 wt% PBSA and from 15 wt% to 35 wt% PLA.

16-17. (canceled)

18. The biodegradable laminated structure of claim 1, wherein said mixture of PCL with PLA comprises from 50 wt% to 80 wt% PLA and from 20 wt% to 50 wt% PCL.

19. (canceled)

20. The biodegradable laminated structure of claim 1, wherein said tie layer comprises 100 wt% PBAT.

21. The biodegradable laminated structure of claim, comprising a sealing sheet having an outer layercomprising a polymer selected from the group consisting of PBSA, PBS, PBAT and a mixture of PCL with PLA and combinations thereof.

22. The biodegradable laminated structure of claim 21, wherein sealing sheet outer layer comprises PBSA and further comprises PLA.

23-26. (canceled)

27. The biodegradable laminated structure of claim 21, wherein said sealing sheet outer layer comprises 100 wt% PBSA.

28. The biodegradable laminated structure of claim 21, wherein said sealing sheet outer layer comprises 100 wt% PBAT.

29. The biodegradable laminated structure according to claim 1, comprising a sealing sheet having a core layer comprising a polymer selected from the group consisting of PBSA, PBS, PBAT and a mixture of PCL with PLA and combinations thereof.

30. The biodegradable laminated structure of claim 29, wherein said sealing sheet core layer comprises PBSA and further comprises PLA.

31-36. (canceled)

37. The biodegradable laminated structure of claim 21, wherein said sealing sheet further comprises a second outer layercomprising a polymer selected from the group consisting of PBSA, PBS, PBAT and a mixture of PCL with PLA and combinations thereof.

38-44. (canceled)

45. The biodegradable laminated structure of claim 10, wherein said intermediate layer comprises cellulose.

46. The biodegradable laminated structure of claim 12, wherein said second tie layer is selected from the group consisting of PBSA and PBAT.

47. (canceled)
